(19) United States
(12) Patent Application Publication
(10) Pub. No.: US 2013/0017478 A1
(43) Pub. Date: Jan. 17, 2013

(54) IMAGE-FORMING APPARATUS, ELECTROPHOTOGRAPHIC PHOTORECEPTOR, AND PROCESS CARTRIDGE

(71) Applicant: Yasuhiro Oda, Kanagawa (JP)

(72) Inventor: Yasuhiro Oda, Kanagawa (JP)

(73) Assignee: FUJI XEROX CO., LTD., Tokyo (JP)

(21) Appl. No.: 13/358,977

(22) Filed: Jan. 26, 2012

(30) Foreign Application Priority Data
Jul. 12, 2011 (JP) 2011-153928

(51) Int. Cl. G03G 15/00; G03G 21/16; G03G 15/06; G03G 9/00

(52) U.S. Cl. 430/56; 399/111; 399/159; 399/222; 430/105

(57) ABSTRACT

An image-forming apparatus includes an electrophotographic photoreceptor including an outermost layer having a crosslinked structure formed by dehydration condensation of a charge transport monomer containing a hydroxyl group and a developing unit that develops an electrostatic latent image on a surface of the electrophotographic photoreceptor with a developer containing a toner manufactured by dispersing particles for forming the toner in a solvent containing water and aggregating and heating the particles to form a toner image. The apparatus satisfies at least one of the following conditions:
(1) the outermost layer of the electrophotographic photoreceptor contains tetrafluoroethylene-containing particles containing a polymer having structural units derived from tetrafluoroethylene;
(2) the developer contains tetrafluoroethylene-containing particles containing a polymer having structural units derived from tetrafluoroethylene; and
(3) the apparatus further includes a supply unit that supplies tetrafluoroethylene-containing particles containing a polymer having structural units derived from tetrafluoroethylene to the surface of the electrophotographic photoreceptor.

### CROSS-REFERENCE TO RELATED APPLICATIONS

This application is based on and claims priority under 35 USC 119 from Japanese Patent Application No. 2011-153928 filed Jul. 12, 2011.

### BACKGROUND

(i) Technical Field

The present invention relates to image-forming apparatuses, electrophotographic photoreceptors, and process cartridges.

(ii) Related Art

To extend the lives of electrophotographic photoreceptors (hereinafter also referred to as “photoreceptors”) for xerographic image-forming apparatuses, resins with high mechanical strength are used as materials for surface layers to inhibit scratches and wear due to electrical and mechanical force exerted by components such as a charging unit, a developing unit, a transfer unit, and a cleaning unit.

### SUMMARY

According to an aspect of the invention, there is provided an image-forming apparatus including an electrophotographic photoreceptor including an outermost layer having a crosslinked structure formed by dehydration condensation of a charge transport monomer containing a hydroxyl group; a charging unit that charges a surface of the electrophotographic photoreceptor; a latent-image forming unit that forms an electrostatic latent image on the charged surface of the electrophotographic photoreceptor; a developing unit that develops the electrostatic latent image on the surface of the electrophotographic photoreceptor with a developer containing a toner manufactured by dispersing particles for forming the toner in a solvent containing water and aggregating and heating the particles to form a toner image; a transfer unit that transfers the toner image from the surface of the electrophotographic photoreceptor onto a transfer medium; and a cleaning unit that removes residual toner from the surface of the electrophotographic photoreceptor after the transfer. The image-forming apparatus satisfies at least one of the following conditions:

(1) the outermost layer of the electrophotographic photoreceptor contains tetrafluoroethylene-containing particles containing a polymer having structural units derived from tetrafluoroethylene;

(2) the developer contains tetrafluoroethylene-containing particles containing a polymer having structural units derived from tetrafluoroethylene; and

(3) the image-forming apparatus further includes a supply unit that supplies tetrafluoroethylene-containing particles containing a polymer having structural units derived from tetrafluoroethylene to the surface of the electrophotographic photoreceptor.

### BRIEF DESCRIPTION OF THE DRAWINGS

Exemplary embodiment(s) of the present invention will be described in detail based on the following figures, wherein:

FIG. 1 is a schematic view showing an example of the structure of an image-forming apparatus according to an exemplary embodiment of the invention;

FIG. 2 is a schematic view showing an example of an electrophotographic photoreceptor used in the exemplary embodiment;

FIG. 3 is a schematic view showing another example of an electrophotographic photoreceptor used in the exemplary embodiment;

FIG. 4 is a schematic view showing another example of an electrophotographic photoreceptor used in the exemplary embodiment;

FIG. 5 is a schematic view showing an example of the structure of an image-forming apparatus according to another exemplary embodiment of the invention; and

FIG. 6 is a schematic view showing an example of bands of decreased image density.

### DETAILED DESCRIPTION

Exemplary embodiments of the present invention will now be described in detail with reference to the attached drawings. In the drawings, the same or corresponding elements are denoted by the same reference numerals, and a redundant description thereof is omitted.

In the formation of an image using a developer containing a toner manufactured by emulsion aggregation with an electrophotographic photoreceptor (hereinafter also simply referred to as “photoreceptor”) including an outermost layer having a crosslinked structure formed by dehydration condensation of a charge transport monomer containing a hydroxyl group, the image may have a band of decreased image density, particularly if the image formation is resumed after several days of nonuse. This is presumably because a slight amount of water remaining in the toner is adsorbed to unreacted hydroxyl groups on the outermost layer of the photoreceptor, thus causing sensitivity variation. In a region locally isolated from outside air by a member that contacts the surface of the photoreceptor, particularly in a region contacted and enclosed by a cleaning device on the surface of the photoreceptor, with toner collected from the surface of the photoreceptor remaining in that region, traces may be left after an extended period of nonuse and be reflected in image density as bands of decreased sensitivity. For example, as shown in FIG. 6, regions 10 with decreased sensitivity tend to be formed at a predetermined interval. The regions 10 correspond to regions isolated from outside air by a cleaning device on the surface of the photoreceptor. Such bands of decreased sensitivity are formed not only by a cleaning device; other devices such as a contact charging device and a developing device are also likely to form bands of decreased sensitivity in regions contacted and locally isolated from outside air on the surface of the photoreceptor.

As a result of studies on inhibiting formation of bands of decreased sensitivity, the inventors have found that formation of traces (regions with decreased sensitivity) due to an extended period of nonuse can be inhibited if tetrafluoroethylene-containing particles containing a polymer having structural units derived from tetrafluoroethylene (ethylene tetrafluoride) are supplied to the surface of the photoreceptor. This is presumably because, among fluorine-containing particles, tetrafluoroethylene-containing particles deform relatively easily under pressure and form and maintain a water-repellant coating on the surface of the photoreceptor, thus effectively inhibiting adsorption of moisture contained in the toner onto the surface of the photoreceptor.

An image-forming apparatus according to an exemplary embodiment of the present invention includes an electrophotographic photoreceptor including an outermost layer having a crosslinked structure formed by dehydration condensation of a charge transport monomer containing a hydroxyl group; a charging unit that charges a surface of the electrophotographic photoreceptor; a latent-image forming unit that forms an electrostatic latent image on the charged surface of the electrophotographic photoreceptor; a developing unit that develops the electrostatic latent image on the surface of the electrophotographic photoreceptor with a developer containing a toner manufactured by dispersing particles for forming the toner in a solvent containing water and aggregating and heating the particles to form a toner image; a transfer unit that transfers the toner image from the surface of the electrophotographic photoreceptor onto a transfer medium; and a cleaning unit that removes residual toner from the surface of the electrophotographic photoreceptor after the transfer. The image-forming apparatus satisfies at least one of the following conditions:

(1) the outermost layer of the electrophotographic photoreceptor contains tetrafluoroethylene-containing particles containing a polymer having structural units derived from tetrafluoroethylene;

(2) the developer contains tetrafluoroethylene-containing particles containing a polymer having structural units derived from tetrafluoroethylene; and

(3) the image-forming apparatus further includes a supply unit that supplies tetrafluoroethylene-containing particles containing a polymer having structural units derived from tetrafluoroethylene to the surface of the electrophotographic photoreceptor.

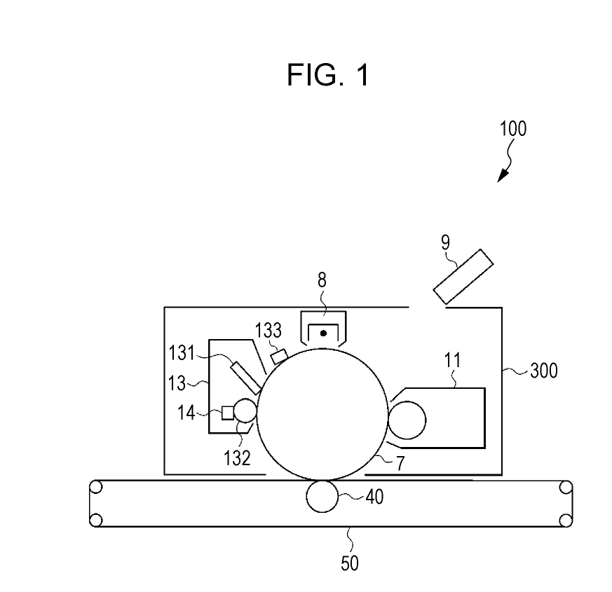

FIG. 1 is a schematic view showing an example of the structure of the image-forming apparatus according to this exemplary embodiment. An image-forming apparatus 100 includes an electrophotographic photoreceptor 7, a charging device 8, an exposure device 9, a developing device 11, a cleaning device 13, a transfer device 40, and an intermediate transfer member 50. The intermediate transfer member 50 is optional; a toner image formed on the surface of the photoreceptor 7 may be directly transferred onto a recording medium (not shown) such as paper.

### Electrophotographic Photoreceptor

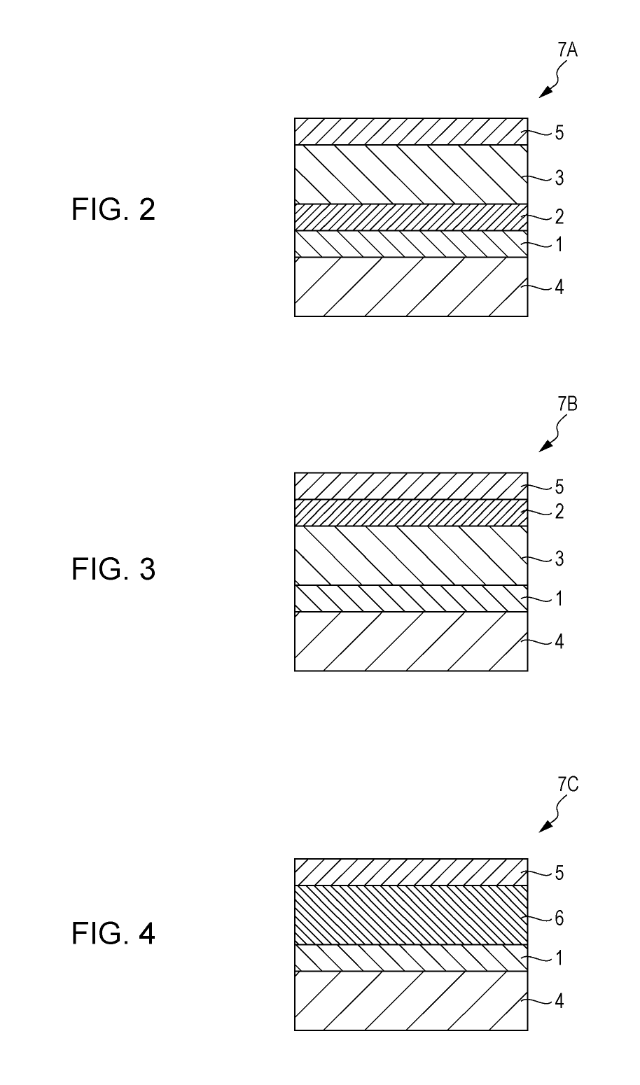

First, an electrophotographic photoreceptor according to this exemplary embodiment will be described. FIG. 2 schematically shows an example of the structure of an electrophotographic photoreceptor according to this exemplary embodiment. FIGS. 3 and 4 schematically show other structures of electrophotographic photoreceptors.

An electrophotographic photoreceptor 7A shown in FIG. 2 is a functionally separated photoreceptor (layered photoreceptor). The electrophotographic photoreceptor 7A includes a conductive support 4, an undercoat layer 1 disposed on the conductive support 4, a photosensitive layer including a charge generating layer 2 and a charge transport layer 3 disposed in the above order on the undercoat layer 1, and a protective layer 5 disposed on the photosensitive layer as an outermost layer.

An electrophotographic photoreceptor 7B shown in FIG. 3 is a functionally separated photoreceptor in which the photosensitive layer is functionally separated into a charge generating layer and a charge transport layer, as in the electrophotographic photoreceptor 7A shown in FIG. 2. The electrophotographic photoreceptor 7B includes a conductive support 4, an undercoat layer 1 disposed on the conductive support 4, a photosensitive layer including a charge transport layer 3 and a charge generating layer 2 disposed in the above order on the undercoat layer 1, and a protective layer 5 disposed on the photosensitive layer.

An electrophotographic photoreceptor 7C shown in FIG. 4 is a functionally integrated photoreceptor in which a charge generating material and a charge transport material are contained in the same layer (charge generating/transport layer). The electrophotographic photoreceptor 7C includes a conductive support 4, an undercoat layer 1 disposed on the conductive support 4, a charge generating/transport layer 6 disposed on the undercoat layer 1, and a protective layer 5 disposed on the charge generating/transport layer 6.

The layer structures of the electrophotographic photoreceptors 7A to 7C shown in FIGS. 2 to 4 are merely illustrative; for example, the undercoat layer 1 does not necessarily have to be disposed, and an intermediate layer may be disposed between the undercoat layer 1 and the photosensitive layer. In addition, the protective layer 5 is optional; the outermost layer may be the photosensitive layer.

As a typical example of this exemplary embodiment, the electrophotographic photoreceptor 7A shown in FIG. 2 will be described for each element.

### Protective Layer

The protective layer 5, which is the outermost layer of the electrophotographic photoreceptor 7A, is disposed to protect the photosensitive layer including the charge generating layer 2 and the charge transport layer 3.

### Charge Transport Monomer Having Hydroxyl Group

The protective layer 5 has a crosslinked structure formed by dehydration condensation of a charge transport monomer containing a hydroxyl group. The charge transport monomer that forms the crosslinked structure of the protective layer 5 may be a monomer having at least one hydroxyl group. A monomer having a larger number of hydroxyl groups forms a crosslinked film with higher crosslink density and strength, thus more effectively inhibiting wear of the electrophotographic photoreceptor 7A. In addition to the hydroxyl group, the charge transport monomer may have a reactive substituent selected from alkoxy, amino, thiol, and carboxyl for improved crosslink density.

The charge transport monomer containing a hydroxyl group may be a compound represented by general formula (I):

F—((—R¹—X)ₙ₁(R²)ₙ₂—Y)ₙ₃ (I)

In general formula (I), F is an organic group derived from a compound having hole transport properties; R¹ and R² are each independently a linear or branched alkylene group having 1 to 5 carbon atoms; n1 is 0 or 1; n2 is 0 or 1; n3 is an integer of 1 to 4; X is oxygen, NH, or sulfur; and Y is a substituent selected from hydroxyl, alkoxy, amino, thiol, and carboxyl, at least one Y being hydroxyl.

In general formula (I), the compound having hole transport properties from which the organic group for F is derived is, for example, ah arylamine derivative. Examples of arylamine derivatives include triphenylamine derivatives and tetraphenylbenzidine derivatives.

The compound represented by general formula (I) may be a compound represented by general formula (II), which is superior in properties such as charge mobility and stability against oxidation:

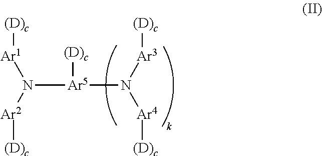

In general formula (II), Ar¹ to Ar⁴ may be the same or different and are each independently a substituted or unsubstituted aryl group; Ar⁵ is a substituted or unsubstituted aryl group or substituted or unsubstituted arylene group; D is —(—R¹—X)ₙ₁(R²)ₙ₂—Y; c is each independently 0 or 1; k is 0 or 1; the total number of Ds is 1 to 4; R¹ and R² are each independently a linear or branched alkylene group having 1 to 5 carbon atoms; n1 is 0 or 1; n2 is 0 or 1; X is oxygen, NH, or sulfur; and Y is a substituent selected from hydroxyl, alkoxy, amino, thiol, and carboxyl, at least one Y being hydroxyl.

In general formula (II), in which the functional group “(—R¹—X)ₙ₁(R²)ₙ₂—Y” at D is similar to that in general formula (I), R¹ and R² are each independently a linear or branched alkylene group having 1 to 5 carbon atoms; n1 is preferably 1; n2 is preferably 1; X is preferably oxygen; and Y is hydroxyl, alkoxy, amino, thiol, or carboxyl, at least one Y being hydroxyl.

The total number of Ds in general formula (II), which corresponds to n3 in general formula (I), is preferably 2 to 4, more preferably 3 or 4. That is, if the total number of Ds in formulae (I) and (II) is 2 to 4, more preferably 3 or 4, per molecule, the crosslinked film attains a higher crosslink density and therefore a higher strength. In particular, this reduces the rotational torque of the electrophotographic photoreceptor 7A during use of a cleaning blade, thus inhibiting damage to the blade and wear of the electrophotographic photoreceptor 7A. Although the details are not well understood, a larger number of Ds presumably increase the number of reactive groups, such as hydroxyl groups, to form a cured film having a higher crosslink density, thus inhibiting the movement of near-surface molecules in the electrophotographic photoreceptor 7A and therefore weakening their interaction with the molecules in the surface of the blade.

In general.formula (II), Ar¹ to Ar⁴ may be represented by one of formulae (1) to (7), where the functional groups “-(D)_{c1}” to “-(D)_{c4}” attached to Ar¹ to Ar⁴, respectively, are collectively referred to as “-(D)_{c}”:

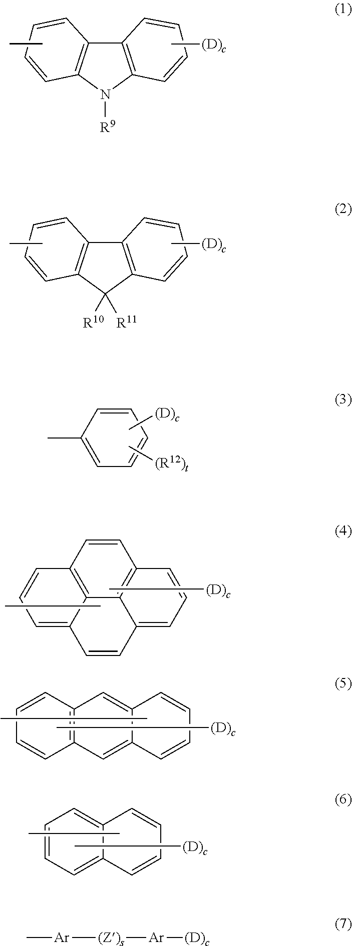

In formulae (1) to (7), R⁹ is selected from the group consisting of hydrogen, alkyl groups having 1 to 4 carbon atoms, phenyl groups substituted with an alkyl group having 1 to 4 carbon atoms or an alkoxy group having 1 to 4 carbon atoms, unsubstituted phenyl groups, and aralkyl groups having 7 to 10 carbon atoms; R¹⁰ to R¹² are each selected from the group consisting of hydrogen, alkyl groups having 1 to 4 carbon atoms, alkoxy groups having 1 to 4 carbon atoms, phenyl groups substituted with an alkoxy group having 1 to 4 carbon atoms, unsubstituted phenyl groups, aralkyl groups having 7 to 10 carbon atoms, and halogens; Ar is a substituted or unsubstituted arylene group; D and c are as defined in general formula (II); s is 0 or 1; and t is an integer of 1 to 3.

In formula (7), Ar may be represented by formula (8) or (9):

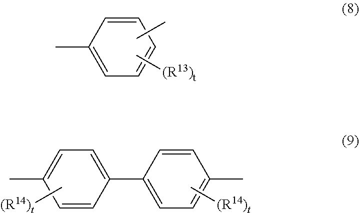

In formulae (8) and (9), R¹⁰ and R¹⁴ are each selected from the group consisting of hydrogen, alkyl groups having 1 to 4 carbon atoms, alkoxy groups having 1 to 4 carbon atoms, phenyl groups substituted with an alkoxy group having 1 to 4 carbon atoms, unsubstituted phenyl groups, aralkyl groups having 7 to 10 carbon atoms, and halogens; and t is an integer of 1 to 3.

In formula (7), Z′ may be represented by one of formulae (10) to (17):

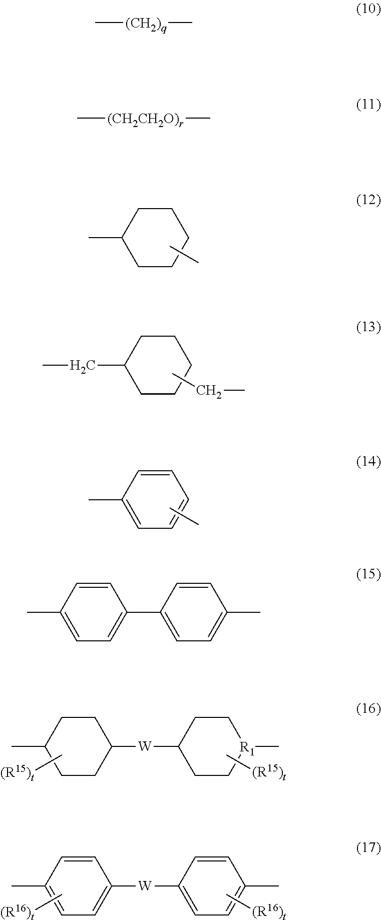

In formulae (10) to (17), R¹⁵ and R¹⁶ are each selected from the group consisting of hydrogen, alkyl groups having 1 to 4 carbon atoms, alkoxy groups having 1 to 4 carbon atoms, phenyl groups substituted with an alkoxy group having 1 to 4 carbon atoms, unsubstituted phenyl groups, aralkyl groups having 7 to 10 carbon atoms, and halogens; W is a divalent group; q and r are each an integer of 1 to 10; and t is each an integer of 1 to 3.

In formulae (16) and (17), W may be a divalent group represented by one of formulae (18) to (26):

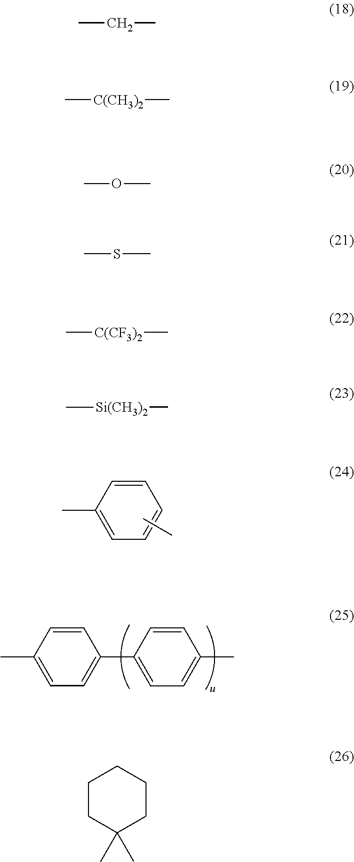

In formula (25), u is an integer of 0 to 3.

In general formula (II), if k is 0, Ar⁵ is an aryl group represented by one of formulae (1) to (7), illustrated above in the description of Ar¹ to Ar⁴; if k is 1, Ar⁵ is an arylene group formed by removing a hydrogen atom from an aryl group represented by one of formulae (1) to (7).

Examples of charge transport compounds containing a hydroxyl group that are represented by general formula (I) include, but not limited to, Compounds I-1 to I-21:

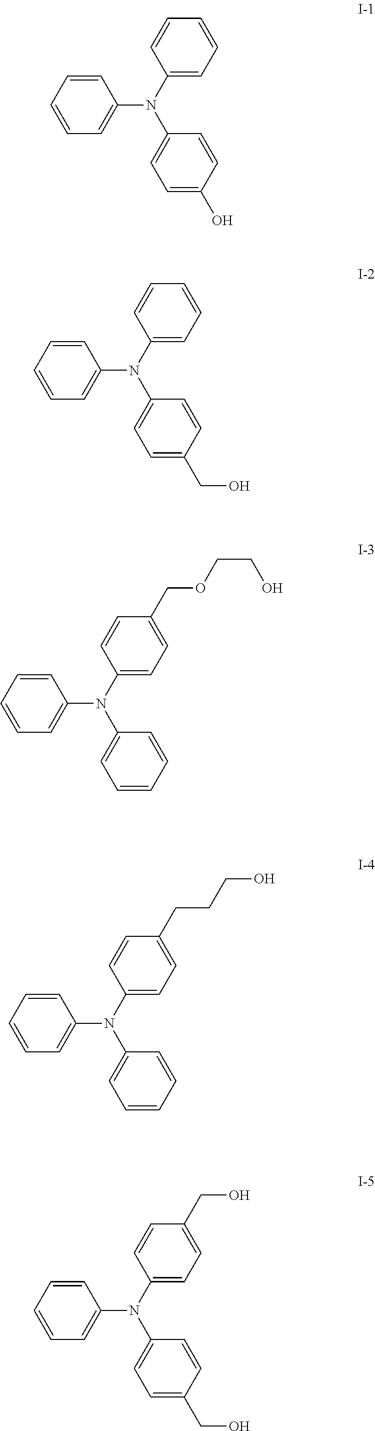

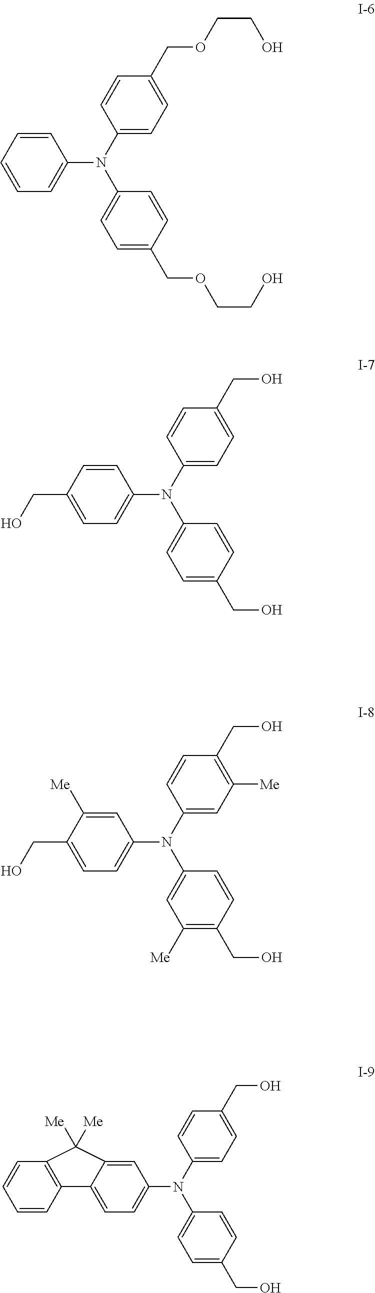

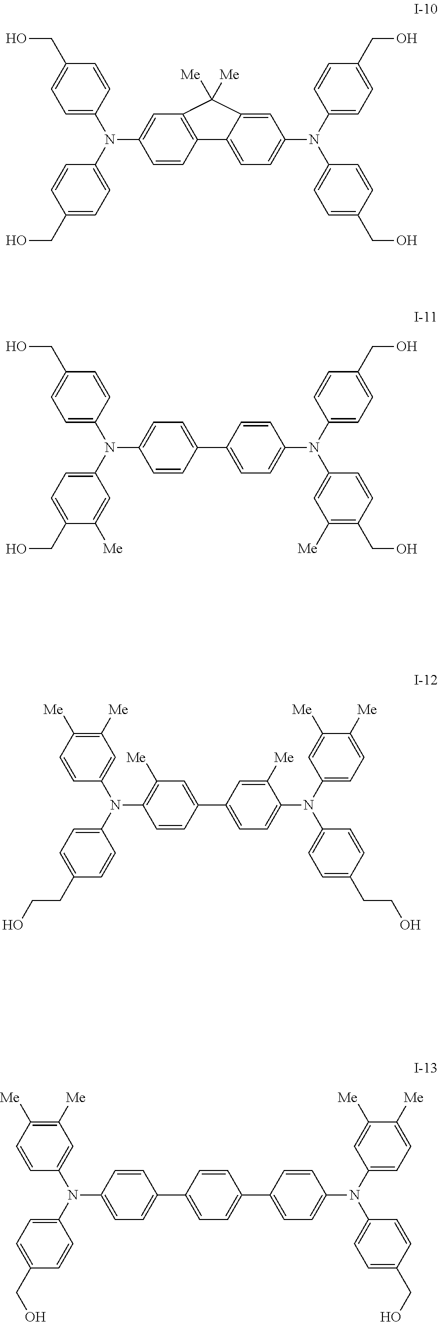

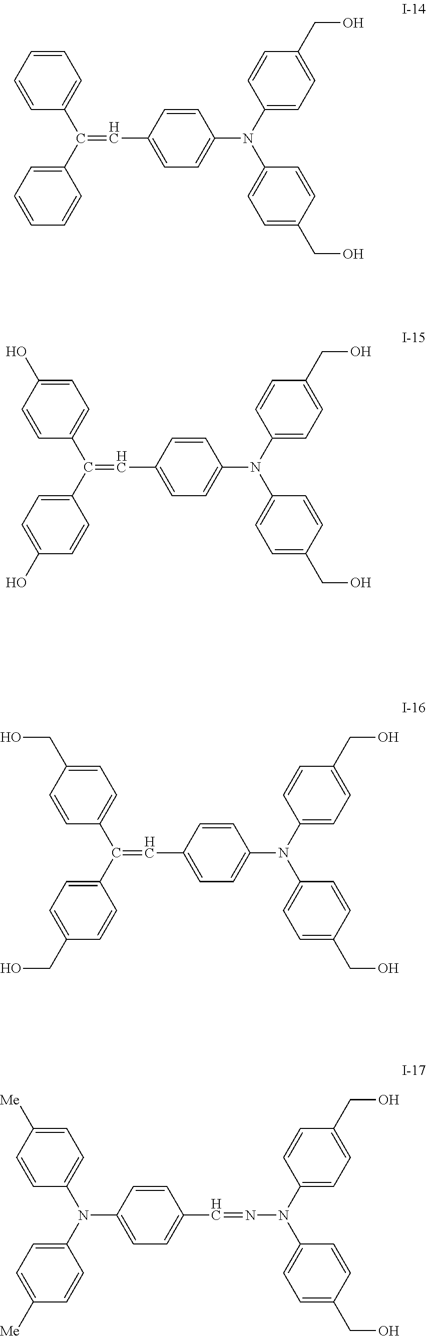

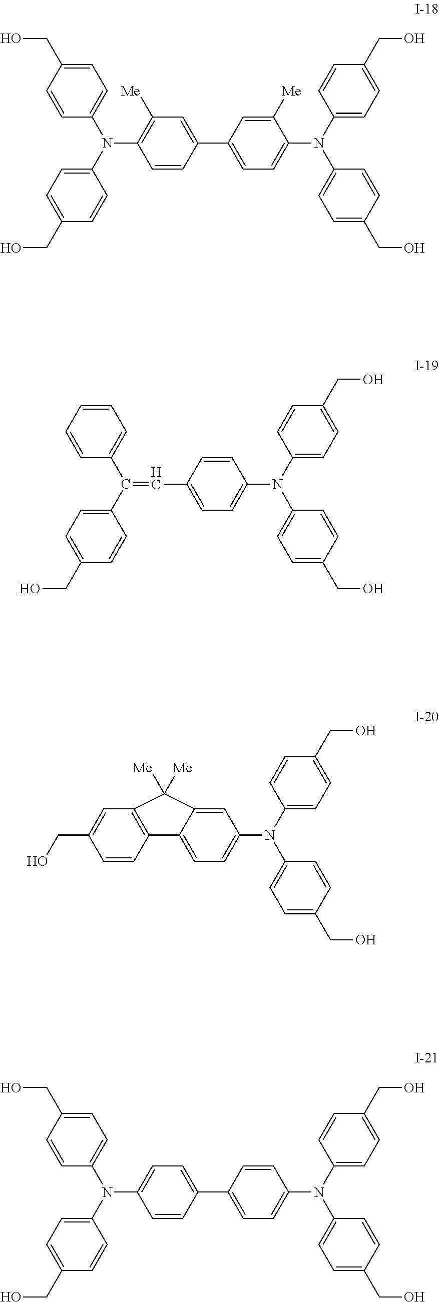

### Tetrafluoroethylene-Containing Particles

The protective layer 5 of the photoreceptor 7A may contain tetrafluoroethylene-containing particles containing a polymer having structural units derived from tetrafluoroethylene. The tetrafluoroethylene-containing particles may be externally supplied to the surface of the photoreceptor 7A in the image-forming apparatus 100 according to this exemplary embodiment; on the other hand, if the tetrafluoroethylene-containing particles are contained in the protective layer 5 of the photoreceptor 7A, they are reliably supplied to the surface of the photoreceptor 7A without being externally supplied as the protective layer 5 wears. The tetrafluoroethylene-containing particles are easily deformed into thin film by a member, such as a cleaning blade, that contacts the surface of the photoreceptor 7A, thus forming a thin film of the polymer having structural units derived from tetrafluoroethylene on the surface of the photoreceptor 7A.

The polymer having structural units derived from tetrafluoroethylene is, for example, a polymer of tetrafluoroethylene or a copolymer of tetrafluoroethylene with another monomer. Specifically, the polymer having structural units derived from tetrafluoroethylene is preferably polytetrafluoroethylene (PTFE), tetrafluoroethylene-hexafluoropropylene copolymer (FEP), or tetrafluoroethylene-perfluoroalkyl vinyl ether copolymer (PFA), more preferably PTFE.

While fluororesin particles, such as polyvinylidene fluoride (PVDF) particles, other than tetrafluoroethylene-containing particles are available, fluororesin particles having no structural units derived from tetrafluoroethylene have no effect of inhibiting formation of bands of decreased image density. This is presumably because fluororesin particles, such as PVDF particles, other than tetrafluoroethylene-containing particles are not easily deformed into a thin film of fluororesin on the surface of the photoreceptor 7A under the pressure exerted by a contact member such as a cleaning blade.

The tetrafluoroethylene-containing particles contained in the protective layer 5 may have a volume average particle size of 1 μm or less or about 1 μm or less. If the tetrafluoroethylene-containing particles have a volume average particle size of 1 μm or less or about 1 μm or less, they are easily deformed into thin film under pressure between a cleaning blade and the photoreceptor 7A. The tetrafluoroethylene-containing particles preferably have a volume average particle size of 0.05 to 0.5 μm, more preferably 0.1 to 0.3 μm.

The particle size of the tetrafluoroethylene-containing particles is measured with an LA-920 laser diffraction particle size distribution analyzer (from Horiba, Ltd.) at a refractive index of 1.35 on a liquid sample prepared by diluting the tetrafluoroethylene-containing particles with the same solvent as used for a dispersion of the tetrafluoroethylene-containing particles.

If the content of the tetrafluoroethylene-containing particles in the protective layer 5 is extremely low, they provide an insufficient effect. If the content of the tetrafluoroethylene-containing particles is extremely high, the frictional coefficient of the surface of the photoreceptor 7A drops excessively, thus decreasing cleaning performance and possibly causing image defects. From these viewpoints, the content of the tetrafluoroethylene-containing particles in the protective layer 5 is preferably 3% to 20% by mass, more preferably 5% to 15% by mass, of the total solid content of the protective layer 5.

In addition to the crosslinked product of the dehydration condensation of the charge transport monomer containing a hydroxyl group and the tetrafluoroethylene-containing particles containing a polymer having structural units derived from tetrafluoroethylene, the protective layer 5 may contain other components such as a fluoroalkyl-containing copolymer, a guanamine compound, a melamine compound, and conductive particles.

### Fluoroalkyl-Containing Copolymer

The protective layer 5 may contain a fluoroalkyl-containing copolymer to maintain the dispersion stability of the tetrafluoroethylene-containing particles.

The fluoroalkyl-containing copolymer contained in the protective layer 5 is preferably, but not limited to, a fluoroalkyl-containing copolymer containing repeating units represented by structural formulae (A) and (B) below, more preferably, a resin synthesized by, for example, graft polymerization of a macromonomer of an acrylate or methacrylate ester with perfluoroalkylethyl (meth)acrylate or perfluoroalkyl (meth)acrylate. As used herein, the term “(meth)acrylate” refers to an acrylate or a methacrylate.

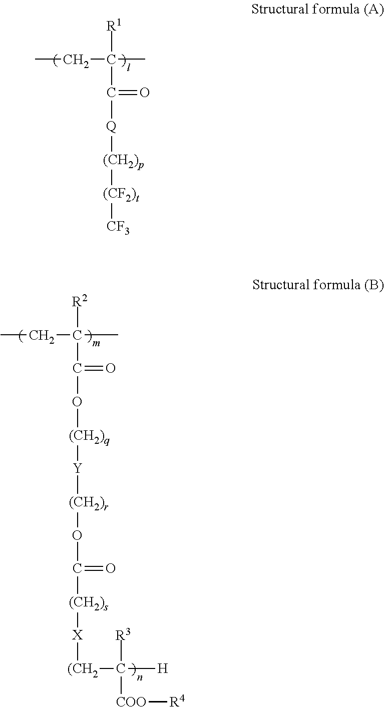

In structural formulae (A) and (B), l, m, and n are integers of 1 or more; p, q, r, and s are integers of 0 or more; t is an integer of 1 to 7; R¹, R²; R³, and R⁴ are hydrogen or alkyl; X is an alkylene chain, a halogen-substituted alkylene chain, —S—, —O—, —NH—, or a single bond; Y is an alkylene chain, a halogen-substituted alkylene chain, —(C_{z}H_{2z-1}(OH))—, or a single bond; z is an integer of 1 or more; and Q is —O— or —NH—.

The fluoroalkyl-containing copolymer preferably has a weight average molecular weight of 10,000 to 100,000, more preferably 30,000 to 100,000.

The ratio of the content of the repeating units represented by structural formula (A) to the content of the repeating units represented by structural formula (B) in the fluoroalkyl-containing copolymer, namely, l:m, is preferably 1:9 to 9:1, more preferably 3:7 to 7:3.

Examples of alkyl groups for R¹, R², R³, and R⁴ in structural formulae (A) and (B) include methyl, ethyl, and propyl. R¹, R², R³, and R⁴ are preferably hydrogen or methyl, more preferably methyl.

The fluoroalkyl-containing copolymer may further contain repeating units represented by structural formula (C). The ratio of the sum of the contents of the repeating units represented by structural formulae (A) and (B), namely, l+m, to the content of the repeating units represented by structural formula (C), namely, l+m:z, is preferably 10:0 to 7:3, more preferably 9:1 to 7:3.

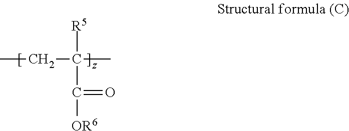

In structural formula (C), R⁵ and R⁶ are hydrogen or alkyl, and z is an integer of 1 or more.

R⁵ and R⁶ are preferably hydrogen, methyl, or ethyl, more preferably methyl.

The content of the fluoroalkyl-containing copolymer in the protective layer 5 may be 1% to 10% of the mass of the tetrafluoroethylene-containing particles.

### Guanamine Compound and Melamine Compound

The protective layer 5 may contain at least one compound selected from compounds having a guanamine structure (hereinafter referred to as “guanamine compound”) and compounds having a melamine structure (hereinafter referred to as “melamine compound”).

The total content of the guanamine compound and the melamine compound may be 0.1% to 20% by mass of the total solid content of the outermost layer excluding the fluororesin particles and the fluoroalkyl-containing copolymer.

If the protective layer 5 contains at least one compound selected from guanamine compounds and melamine compounds, it improves the wear resistance and electrical stability of the electrophotographic photoreceptor 7A and allows high-quality images to be repeatedly formed without image defects, thus further increasing the reliability and life of the image-forming apparatus 100.

The guanamine compound will now be described. The guanamine compound used in this exemplary embodiment is a compound having a guanamine backbone (structure), such as acetoguanamine, benzoguanamine, formoguanamine, steroguanamine, spiroguanamine, or cyclohexylguanamine.

In particular, the guanamine compound may be at least one of compounds represented by general formula (A) below and multimers thereof. As used herein, the term “multimer” refers to an oligomer formed by polymerizing a compound represented by general formula (A) as structural units to a degree of polymerization of, for example, 2 to 200 (preferably, 2 to 100). Compounds represented by general formula (A) may be used alone or in a combination of two or more. In particular, a mixture of two or more compounds represented by general formula (A) or a multimer (oligomer) thereof may be used to improve the solubility in solvent.

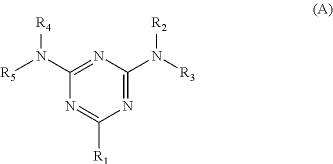

In general formula (A), R₁ is a linear or branched alkyl group having 1 to 10 carbon atoms, a substituted or unsubstituted phenyl group having 6 to 10 carbon atoms, or a substituted or unsubstituted alicyclic hydrocarbon group having 4 to 10 carbon atoms; and R₂ to R₅ are each independently hydrogen, —CH₂—OH, or —CH₂—O—R₆, where R₆ is a linear or branched alkyl group having 1 to 10 carbon atoms.

In general formula (A), the alkyl group for R₁ has 1 to 10 carbon atoms, preferably 1 to 8 carbon atoms, more preferably 1 to 5 carbon atoms. The alkyl group may be either linear or branched.

In general formula (A), the phenyl group for R₁ has 6 to 10 carbon atoms, preferably 6 to 8 carbon atoms. Examples of substituents on the phenyl group include methyl, ethyl, or propyl.

In general formula (A), the alicyclic hydrocarbon group for R₁ has 4 to 10 carbon atoms, preferably 5 to 8 carbon atoms. Examples of substituents on the alicyclic hydrocarbon group include methyl, ethyl, and propyl.

In the functional group “—CH₂—O—R₆” for R₂ to R₅ in general formula (A), the alkyl group for R₆ has 1 to 10 carbon atoms, preferably 1 to 8 carbon atoms, more preferably 1 to 6 carbon atoms. The alkyl group may be either linear or branched. Examples of alkyl groups include methyl, ethyl, and butyl.

In particular, the compound represented by general formula (A) is preferably a compound where R₁ is a substituted or unsubstituted phenyl group having 6 to 10 carbon atoms, and R₂ to R₅ are each independently CH₂—O—R₆. In addition, R₆ is preferably selected from methyl and n-butyl.

The compound represented by general formula (A) is synthesized, for example, using guanamine and formaldehyde by a known method (for example, The Fourth Series of Experimental Chemistry (Jikken Kagaku Koza 4th Ed.), vol. 28, p. 430).

Examples of compounds represented by general formula (A) include, but not limited to, the following monomers and multimers (oligomer) thereof:

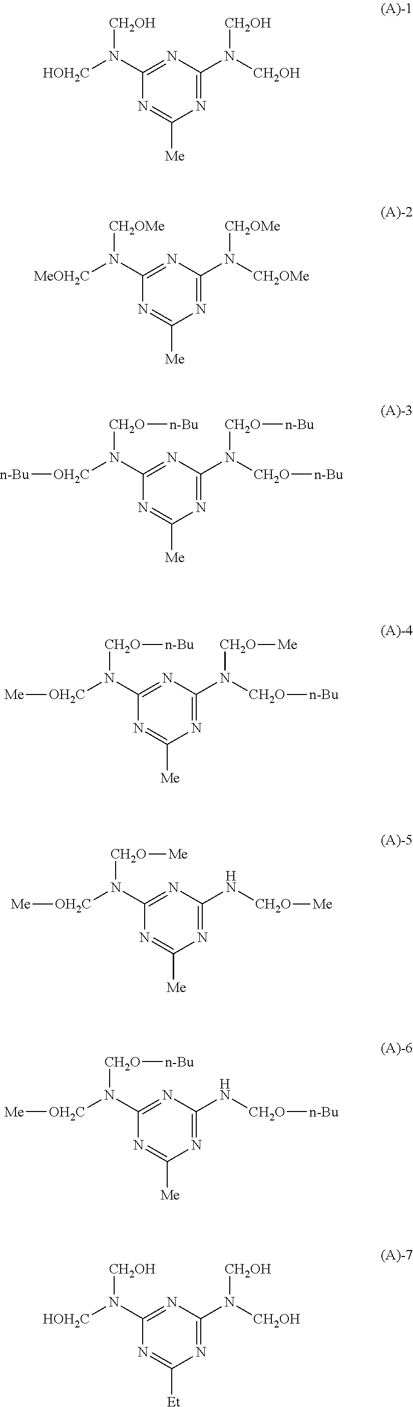

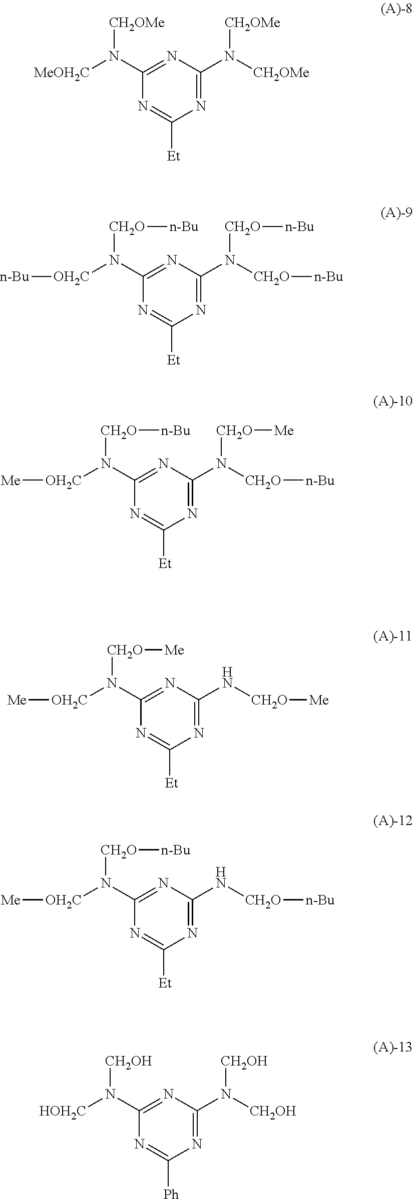

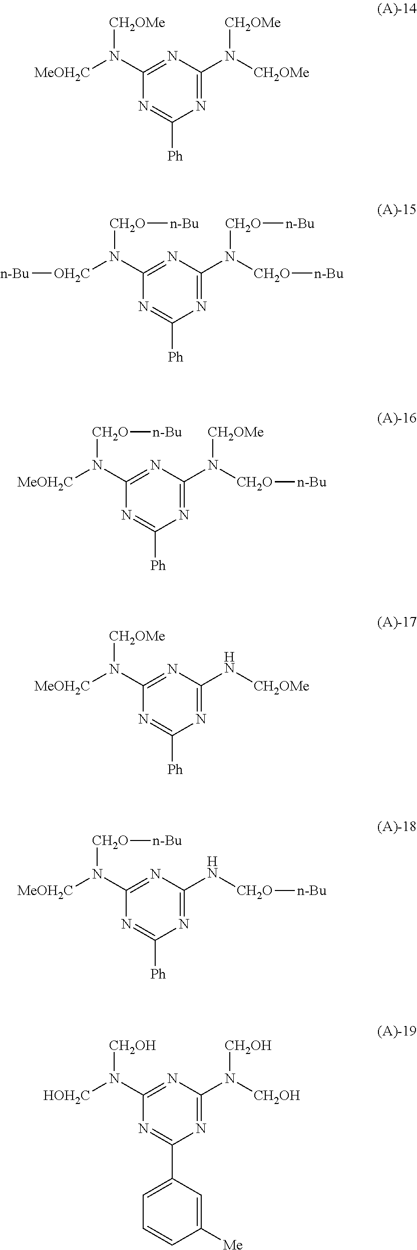

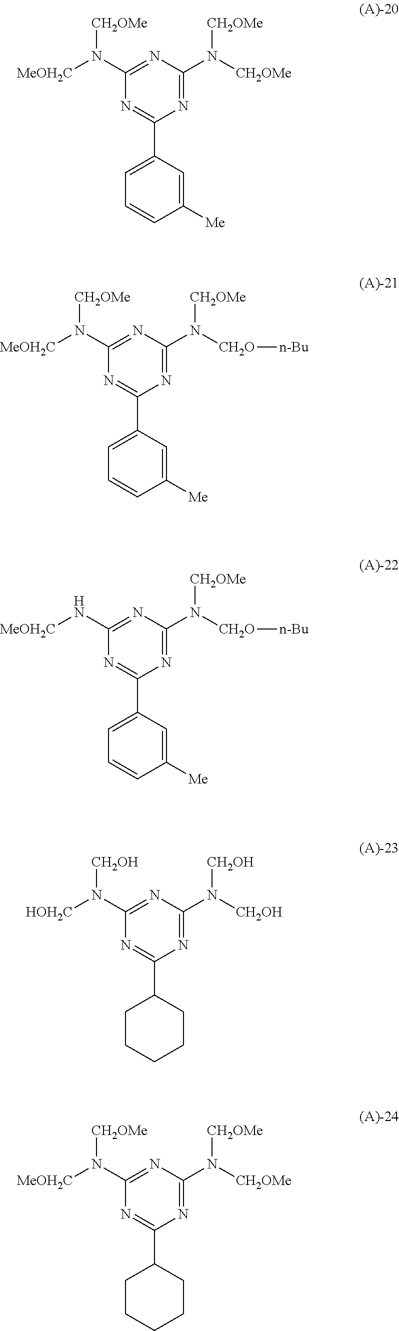

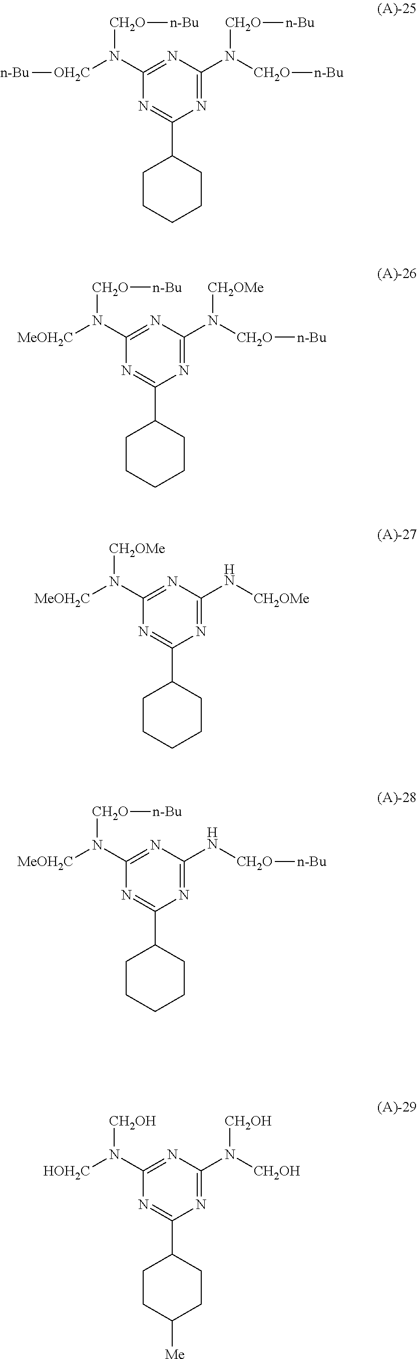

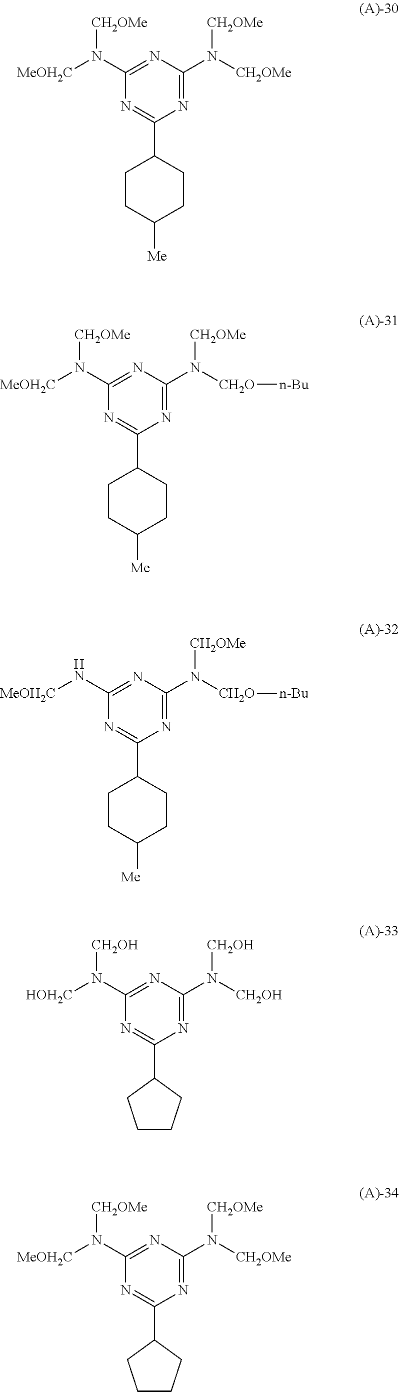

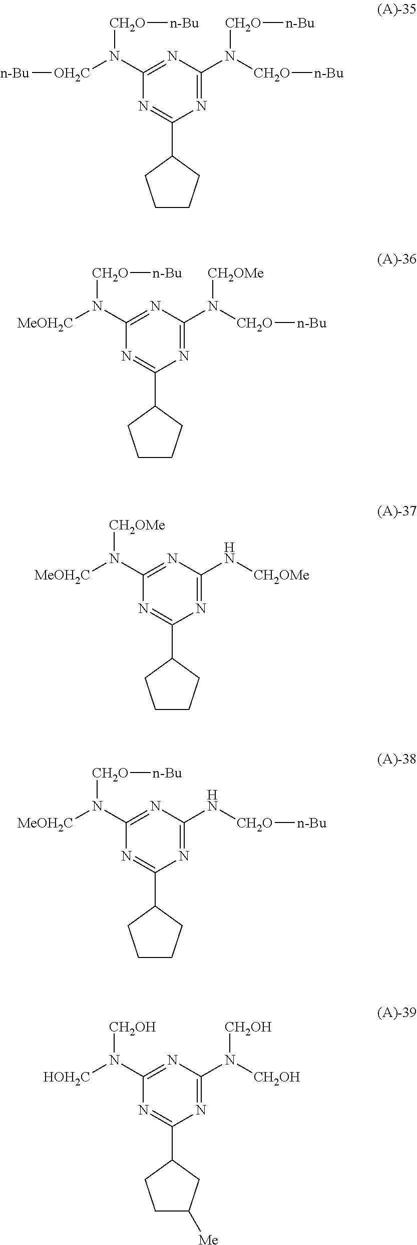

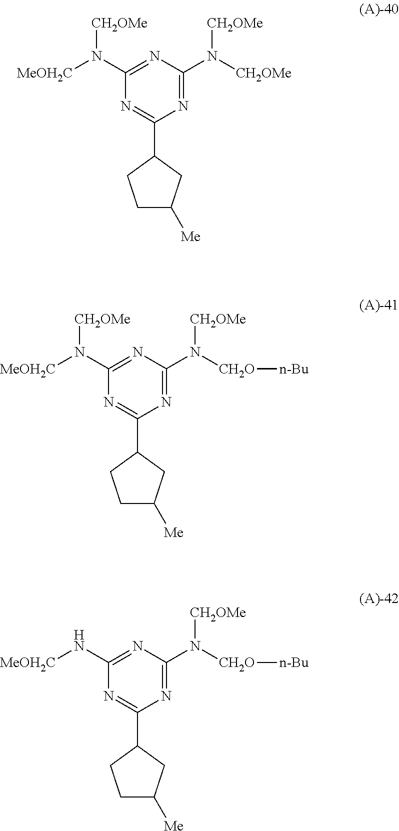

Examples of commercial products of compounds represented by general formula (A) include SUPER BECKAMINE® L-148-55, SUPER BECKAMINE® 13-535, SUPER BECKAMINE® L-145-60, and SUPER BECKAMINE® TD-126 (from DIC Corporation) and NIKALAC BL-60 and NIKALA BX-4000 (from Nippon Carbide Industries Co., Inc.).

To remove residual catalyst from a synthesized or purchased compound (including multimers) represented by general formula (A), the compound may be dissolved in an appropriate solvent such as toluene, xylene, or ethyl acetate and be cleaned with, for example, distilled water or ion exchange water or be treated with an ion exchange resin.

The melamine compound will then be described. The melamine compound used in this exemplary embodiment is a compound having a melamine backbone (structure). In particular, the melamine compound may be at least one of compounds represented by general formula (B) below and multimers thereof. As used herein, the term “multimer” refers to an oligomer formed by polymerizing a compound represented by general formula (B) as structural units to a degree of polymerization of, for example, 2 to 200 (preferably, 2 to 100). Compounds represented by general formula (B) or multimers thereof may be used alone or in a combination of two or more, and may be used in combination with compounds represented by general formula (A) or multimers thereof. In particular, a mixture of two or more compounds represented by general formula (B) or a multimer (oligomer) thereof may be used to improve the solubility in solvent.

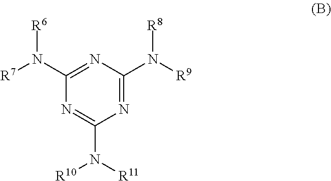

In general formula (B), R⁶ to R¹¹ are each independently hydrogen, —CH₂—OH, or —CH₂—O—R¹², and R¹² is an optionally branched alkyl group having 1 to 5 carbon atoms. Examples of alkyl groups include methyl, ethyl, and butyl.

The compound represented by general formula (B) is synthesized, for example, using melamine and formaldehyde by a known method (for example, as in the synthesis of a melamine resin in The Fourth Series of Experimental Chemistry (Jikken Kagaku Koza 4th Ed.), vol. 28, p. 430).

Examples of compounds represented by general formula (B) include, but not limited to, the following monomers and multimers (oligomer) thereof:

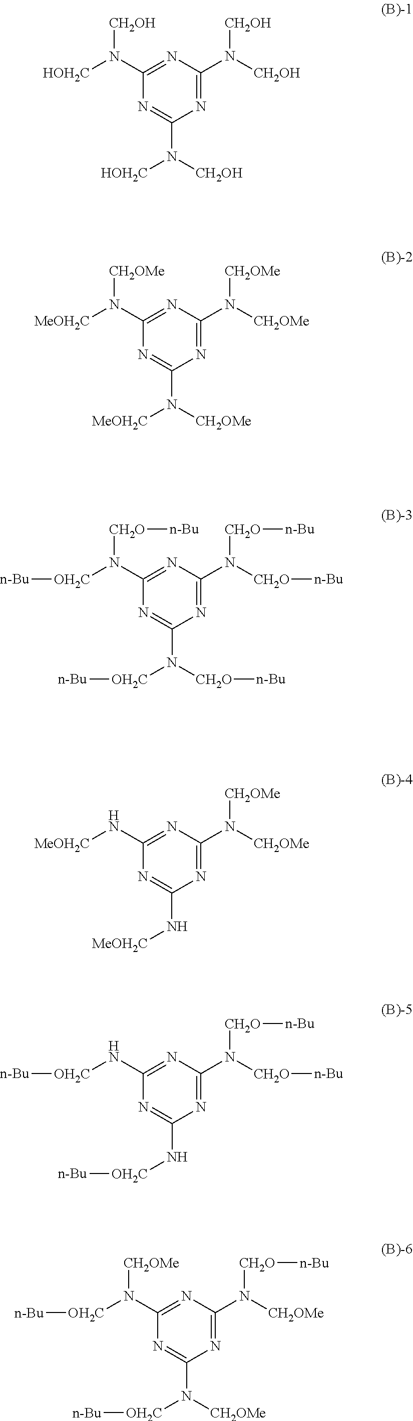

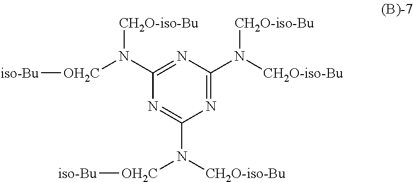

Examples of commercial products of compounds represented by general formula (B) include SUPER MELAMI No. 90 (from NOF Corporation), SUPER BECKAMINE® TD-139-60 (from DIC Corporation), U-VAN 2020 (from Mitsui Chemicals, Inc.), Sumitex Resin M-3 (from Sumitomo Chemical Co., Ltd.), and NIKALAC MW-30 (from Nippon Carbide Industries Co., Inc.).

To remove residual catalyst from a synthesized or purchased compound (including multimers) represented by general formula (B), it may be dissolved in an appropriate solvent such as toluene, xylene, or ethyl acetate and be cleaned with, for example, distilled water or ion exchange water or be treated with an ion exchange resin.

The total content of the guanamine compound and the melamine compound in the protective layer 5 may be 0.1% to 20% by mass of the total solid content of the protective layer 5.

If the total content of the guanamine compound (for example, a compound represented by general formula (A)) and the melamine compound (for example, a compound represented by general formula (B)) in the protective layer 5 falls within the above range, the protective layer 5 becomes more dense and wear-resistant than one containing the guanamine compound and the melamine compound in an amount below the above range. In addition, the photosensitive layer 5 has better electrical properties and ghost resistance than one containing the guanamine compound and the melamine compound in an amount outside the above range.

The total content of the charge transport compound and the total content of the guanamine compound and the melamine compound in the protective layer 5 are controlled by adjusting their solid concentrations in a coating liquid for forming the protective layer 5.

### Other Components

An oil such as silicone oil may be added to improve the contamination resistance and lubricity of the surface of the photoreceptor 7A. Examples of silicone oils include silicone oils such as dimethylpolysiloxane, diphenylpolysiloxane, and phenylmethylpolysiloxane; and reactive silicone oils such as amino-modified polysiloxane, epoxy-modified polysiloxane, carboxyl-modified polysiloxane, carbinol-modified polysiloxane, fluorine-modified polysiloxane, methacryl-modified polysiloxane, mercapto-modified polysiloxane, and phenol-modified polysiloxane.

The protective layer 5 may contain another thermoplastic resin such as a phenolic resin, melamine resin, urea resin, alkyd resin, or benzoguanamine resin. In addition, the components in the crosslinked product may be copolymerized with a compound having a larger number of functional groups in one molecule, such as a spiroacetal guanamine resin (e.g., “CTU-Guanamine” from Ajinomoto Fine-Techno Co., Inc.).

The protective layer 5 may contain a surfactant. Examples of surfactants include those having at least one of fluorine, an alkylene oxide structure, and a silicone structure.

The protective layer 5 may contain an antioxidant. Examples of antioxidants include hindered phenols, hindered amines, and other known antioxidants such as organosulfur antioxidants, phosphite antioxidants, dithiocarbamate antioxidants, thiourea antioxidants, and benzoimidazole antioxidants. The amount of antioxidant added is preferably 20% by mass or less, more preferably 10% by mass or less.

Examples of hindered phenols include 2,6-di-t-butyl-4-methylphenol, 2,5-di-t-butylhydroquinone, N,N′-hexamethylenebis(3,5-di-t-butyl-4-hydroxyhydrocinnamide), 3,5-di-t-butyl-4-hydroxybenzylphosphonate diethyl ester, 2,4-bis[(octylthio)methyl]-o-cresol, 2,6-di-t-butyl-4-ethylphenol, 2,2′-methylenebis(4-methyl-6-t-butylphenol), 2,2′-methylenebis(4-ethyl-6-t-butylphenol), 4,4′-butylidenebis(3-methyl-6-t-butylphenol), 2,5-di-t-amylhydroquinone, 2-t-butyl-6-(3-butyl-2-hydroxy-5-methylbenzyl)-4-methylphenyl acrylate, and 4,4′-butylidenebis(3-methyl-6-t-butylphenol).

The protective layer 5 may contain a curing catalyst for facilitating curing. The curing catalyst used may be an acid catalyst. Examples of acid catalysts include aliphatic carboxylic acids such as acetic acid, chloroacetic acid, trichloroacetic acid, trifluoroacetic acid, oxalic acid, maleic acid, malonic acid, and lactic acid; aromatic carboxylic acids such as benzoic acid, phthalic acid, terephthalic acid, and trimellitic acid; and aliphatic and aromatic sulfonic acids such as methanesulfonic acid, dodecylsulfonic acid, benzenesulfonic acid, dodecylbenzenesulfonic acid, and naphthalenesulfonic acid, of which sulfur-containing materials are preferably used.

The sulfur-containing material used as a curing catalyst is preferably one that shows acidity at room temperature (for example, 25° C.) or when heated, more preferably at least one of organic sulfonic acids and derivatives thereof.

Examples of organic sulfonic acids and derivatives thereof include paratoluenesulfonic acid, dinonylnaphthalenesulfonic acid (DNNSA), dinonylnaphthalenedisulfonic acid (DNNDSA), dodecylbenzenesulfonic acid, and phenolsulfonic acid. Of these, paratoluenesulfonic acid and dodecylbenzenesulfonic acid are preferred. Organic sulfonic acid salts that can dissociate in a curable resin composition may also be used.

In addition, thermally latent catalysts, which exhibit higher catalytic activity when heated, may be used.

Examples of thermally latent catalysts include microcapsules prepared by coating, for example, an organic sulfone compound with a polymer in particle form; porous compounds, such as zeolite, on which an acid is adsorbed; thermally latent protonic acid catalysts prepared by blocking a protonic acid and/or a protonic acid derivative with a base; thermally latent protonic acid catalysts prepared by esterifying a protonic acid and/or a protonic acid derivative with a primary or secondary alcohol; thermally latent protonic acid catalysts prepared by blocking a protonic acid and/or a protonic acid derivative with a vinyl ether and/or a vinyl thioether; boron trifluoride monoethylamine complex; and boron trifluoride pyridine complex.

In particular, thermally latent protonic acid catalysts prepared by blocking a protonic acid and/or a protonic acid derivative with a base are preferred.

Examples of protonic acids for thermally latent protonic acid catalysts include sulfuric acid, hydrochloric acid, acetic acid, formic acid, nitric acid, phosphoric acid, sulfonic acid, monocarboxylic acids, polycarboxylic acids, propionic acid, oxalic acid, benzoic acid, acrylic acid, methacrylic acid, itaconic acid, phthalic acid, maleic acid, benzenesulfonic acid, o-, m-, and p-toluenesulfonic acids, styrenesulfonic acid, dinonylnaphthalenesulfonic acid, dinonylnaphthalenedisulfonic acid, decylbenzenesulfonic acid, undecylbenzenesulfonic acid, tridecylbenzenesulfonic acid, tetradecylbenzenesulfonic acid, and dodecylbenzenesulfonic acid. Examples of protonic acid derivatives include neutralized products, such as alkali metal salts and alkaline metal salts, of protonic acids such as sulfonic acid and phosphoric acid; and polymeric compounds having a protonic acid structure in the polymer chain thereof (such as polyvinylsulfonic acid). Examples of bases for blocking protonic acids include amines.

Amines are divided into primary, secondary, and tertiary amines, any of which may be used without a particular limitation.

Examples of primary amines include methylamine, ethylamine, propylamine, isopropylamine, n-butylamine, isobutylamine, t-butylamine, hexylamine, 2-ethylhexylamine, sec-butylamine, allylamine, and methylhexylamine.

Examples of secondary amines include dimethylamine, diethylamine, di-n-propylamine, diisopropylamine, di-n-butylamine, diisobutylamine, di-t-butylamine, dihexylamine, di(2-ethylhexyl)amine, N-isopropyl-N-isobutylamine, di(2-ethylhexyl)amine, di-sec-butylamine, diallylamine, N-methylhexylamine, 3-pipecoline, 4-pipecoline, 2,4-lupetidine, 2,6-lupetidine, 3,5-lupetidine, morpholine, and N-methylbenzylamine.

Examples of tertiary amines include trimethylamine, triethylamine, tri-n-propylamine, triisopropylamine, tri-n-butylamine, triisobutylamine, tri-t-butylamine, trihexylamine, tri(2-ethylhexyl)amine, N-methylmorpholine, N,N-dimethylallylamine, N-methyldiallylamine, triallylamine, N,N-dimethylallylamine, N,N,N′,N′-tetramethyl-1,2-diaminoethane, N,N,N′,N′-tetramethyl-1,3-diaminopropane, N,N,N′,N′-tetraallyl-1,4-diaminobutane, N-methylpiperidine, pyridine, 4-ethylpyridine, N-propyldiallylamine, 3-dimethylaminopropanol, 2-ethylpyrazine, 2,3-dimethylpyrazine, 2,5-dimethylpyrazine, 2,4-lutidine, 2,5-lutidine, 3,4-lutidine, 3,5-lutidine, 2,4,6-collidine, 2-methyl-4-ethylpyridine, 2-methyl-5-ethylpyridine, N,N,N′,N′-tetramethylhexamethylenediamine, N-ethyl-3-hydroxypiperidine, 3-methyl-4-ethylpyridine, 3-ethyl-4-methylpyridine, 4-(5-nonyl)pyridine, imidazole, and N-methylpiperazine.

Examples of commercial products include “NACURE 2501” (toluenesulfonic acid dissociated; solvent: methanol/isopropanol; pH: 6.0 to 7.2; dissociation temperature: 80° C.), “NACURE 2107” (p-toluenesulfonic acid dissociated; solvent: isopropanol; pH: 8.0 to 9.0; dissociation temperature: 90° C.), “NACURE 2500” (p-toluenesulfonic acid dissociated; solvent: isopropanol; pH: 6.0 to 7.0; dissociation temperature: 65° C.), “NACURE 2530” (p-toluenesulfonic acid dissociated; solvent: methanol/isopropanol; pH: 5.7 to 6.5; dissociation temperature: 65° C.), “NACURE 2547” (p-toluenesulfonic acid dissociated; aqueous solution; pH: 8.0 to 9.0; dissociation temperature: 107° C.), “NACURE 2558” (p-toluenesulfonic acid dissociated: solvent: ethylene glycol; pH: 3.5 to 4.5; dissociation temperature: 80° C.), “NACURE XP-357” (p-toluenesulfonic acid dissociated: solvent: methanol; pH: 2.0 to 4.0; dissociation temperature: 65° C.), “NACURE XP-386” (p-toluenesulfonic acid dissociated; aqueous solution; pH: 6.1 to 6.4; dissociation temperature: 80° C.), “NACURE XC-2211” (p-toluenesulfonic acid dissociated; pH: 7.2 to 8.5; dissociation temperature: 80° C.), “NACURE 5225” (dodecylbenzenesulfonic acid dissociated; solvent: isopropanol; pH: 6.0 to 7.0; dissociation temperature: 120° C.), “NACURE 5414” (dodecylbenzenesulfonic acid dissociated; solvent: xylene; dissociation temperature: 120° C.), “NACURE 5528” (dodecylbenzenesulfonic acid dissociated; solvent: isopropanol; pH: 7.0 to 8.0; dissociation temperature: 120° C.), “NACURE 5925” (dodecylbenzenesulfonic acid dissociated; pH: 7.0 to 7.5; dissociation temperature: 130° C.), “NACURE 1323” (dinonylnaphthalenesulfonic acid dissociated; solvent: xylene; pH: 6.8 to 7.5; dissociation temperature: 150° C.), “NACURE 1419” (dinonylnaphthalenesulfonic acid dissociated; solvent: xylene/methyl isobutyl ketone; dissociation temperature: 150° C.), “NACURE 1557” (dinonylnaphthalenesulfonic acid dissociated; solvent: butanol/2-butoxyethanol; pH: 6.5 to 7.5; dissociation temperature: 150° C.), “NACURE X49-110” (dinonylnaphthalenedisulfonic acid dissociated; solvent: isobutanol/isopropanol; pH: 6.5 to 7.5; dissociation temperature: 90° C.), “NACURE 3525” (dinonylnaphthalenedisulfonic acid dissociated, isobutanol/isopropanol solvent; pH: 7.0 to 8.5; dissociation temperature: 120° C.), “NACURE XP-383” (dinonylnaphthalenedisulfonic acid dissociated; solvent: xylene; dissociation temperature: 120° C.), “NACURE 3327” (dinonylnaphthalenedisulfonic acid dissociated; solvent: isobutanol/isopropanol; pH: 6.5 to 7.5; dissociation temperature: 150° C.), “NACURE 4167” (phosphoric acid dissociated; solvent: isopropanol/isobutanol; pH: 6.8 to 7.3; dissociation temperature: 80° C.), “NACURE XP-297” (phosphoric acid dissociated; solvent: water/isopropanol; pH: 6.5 to 7.5; dissociation temperature: 90° C., and “NACURE 4575” (phosphoric acid dissociated; pH: 7.0 to 8.0; dissociation temperature: 110° C.) (from King Industries, Inc.).

These thermally latent catalysts may be used alone or in a combination of two or more.

The catalyst content is preferably 0.1% to 10% by mass, more preferably 0.1% to 5% by mass, of the total solid content of a coating liquid for forming the protective layer 5 excluding the tetrafluoroethylene-containing particles and the fluoroalkyl-containing copolymer.

### Formation of Protective Layer

After the undercoat layer 1, the charge generating layer 2, and the charge transport layer 3 are formed on the conductive support 4 in the above order, the protective layer 5 is formed thereon by applying and crosslinking a coating liquid for forming the protective layer 5.

Examples of solvents used for forming the protective layer 5 include alicyclic ketones such as cyclobutanone, cyclopentanone, cyclohexanone, and cycloheptanone. Alicyclic ketones may be used in combination with other solvents, including cyclic or liner alcohols such as methanol, ethanol, propanol, butanol, and cyclopentanol; linear ketones such as acetone and methyl ethyl ketone; cyclic or linear ethers such as tetrahydrofuran, dioxane, ethylene glycol, and diethyl ether; and halogenated aliphatic hydrocarbons such as methylene chloride, chloroform, and ethylene chloride.

Preferred alicyclic ketones include those having 4 to 7 ring-forming carbon atoms, more preferably 5 or 6 ring-forming carbon atoms.

Examples of coating processes for forming the protective layer 5 include known coating processes such as ring coating, blade coating, Meyer bar coating, spray coating, dip coating, bead coating, air knife coating, curtain coating, and inkjet coating.

The coating is cured (crosslinked) by heating at, for example, 100° C. to 170° C. to form the protective layer 5.

The protective layer 5 may have a thickness of 1 to 20 μm for extended life and stable image quality.

### Conductive Support

Examples of conductive supports include metal drums such as aluminum, copper, iron, stainless steel, zinc, and nickel drums; substrates, such as sheets, paper, plastic, and glass, on which a metal such as aluminum, copper, gold, silver, platinum, palladium, titanium, nickel-chromium, stainless steel, or copper-indium is deposited; substrates, as shown above, on which a conductive metal compound such as indium oxide or tin oxide is deposited; substrates, as shown above, on which a metal foil is laminated; and substrates, as shown above, made conductive by applying a dispersion of a conductive material such as carbon black, indium oxide, tin oxide-antimony oxide powder, metal powder, or copper iodide in a binder resin. As used herein, the term “conductive” refers to having a volume resistivity of less than 10¹³ Ωcm.

The conductive support 4 may have a drum, sheet, or plate shape. For example, if the conductive support 4 is a metal pipe, the surface thereof may be untreated or may be roughened in advance by surface treatment. Such roughening avoids wood-grain-like concentration variations due to interference light that can occur in the photoreceptor 7A if the exposure light source used is a coherent light source such as a laser. Examples of surface treatment processes include mirror cutting, etching, anodizing, rough cutting, centerless grinding, sand blasting, and wet honing.

In particular, for example, anodized aluminum may be used as the conductive support 4 for improved adhesion to and coverage with the photosensitive layer.

### Undercoat Layer

The undercoat layer 1 is optionally provided, for example, to prevent light reflection on the surface of the support 4 and to block an undesirable flow of carriers from the support 4 into the protective layer 5.

Examples of materials for the undercoat layer 1 include metal powders such as aluminum, copper, nickel, and silver powders; conductive metal oxides such as antimony oxide, indium oxide, tin oxide, and zinc oxide; and other conductive materials such as carbon fiber, carbon black, and graphite powder. Such a material is dispersed in a binder resin and is applied onto the support 4. Two or more conductive metal oxides may also be used as a mixture. A conductive metal oxide may be subjected to surface treatment with a coupling agent for powder resistance control.

Examples of binder resins used for the undercoat layer 1 include known polymer resin compounds such as acetal resins (such as polyvinyl butyral), polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenolic resins, phenolic-formaldehyde resins, melamine resins, and urethane resins. Other examples include charge transport resins having a charge transport group and conductive resins such as polyaniline.

The conductive metal oxide resin may be mixed at any ratio with the binder in the undercoat layer 1, and it may be appropriately set.

The undercoat layer 1 may contain an acceptor compound (electron-accepting material). Any acceptor compound may be used. Examples of acceptor compounds include electron transport materials, for example, quinones such as chloranil and bromanil; tetracyanoquinodimethanes; fluorenones such as 2,4,7-trinitrofluorenone and 2,4,5,7-tetranitro-9-fluorenone; oxadiazoles such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthones; thiophenes; and diphenoquinones such as 3,3′,5,5′-tetra-t-butyldiphenoquinone. Other examples include acceptor compounds having an anthraquinone structure, such as hydroxyanthraquinones, aminoanthraquinones, and aminohydroxyanthraquinones, including anthraquinone, alizarin, quinizarin, anthrarufin, and purpurin.

The content of the acceptor compound may be appropriately set. Preferably, the content of the acceptor compound is 0.01% to 20% by mass, more preferably 0.05% to 10% by mass, of the content of the inorganic particles.

The acceptor compound may be simply added before coating or may be deposited on the surfaces of the inorganic particles in advance. Examples of processes for depositing the acceptor compound on the surfaces of the inorganic particles include dry processes and wet processes.

The undercoat layer 1 is formed using a coating liquid containing the above components and a solvent. Examples of solvents include aromatic hydrocarbon solvents such as toluene and chlorobenzene; fatty alcohol solvents such as methanol, ethanol, n-propanol, isopropanol, and n-butanol; ketone solvents such as acetone, cyclohexanone, and 2-butanone; halogenated aliphatic hydrocarbon solvents such as methylene chloride, chloroform, and ethylene chloride; cyclic or linear ether solvents such as tetrahydrofuran, dioxane, ethylene glycol, and diethyl ether; and ester solvents such as methyl acetate, ethyl acetate, and n-butyl acetate. These solvents may be used alone or in a combination of two or more. Any solvent that can dissolve the binder resin as a mixed solvent may be used for mixing.

Examples of techniques available for dispersing the conductive metal oxide in the coating liquid for forming the undercoat layer 1 include media dispersing machines such as ball mills, vibrating ball mills, attritors, sand mills, and horizontal sand mills and media-less dispersing machines such as stirrers, sonicators, roller mills, and high-pressure homogenizers. Examples of high-pressure homogenizers include collision-type homogenizers, which perform dispersion by liquid-liquid collision or liquid-wall collision under high pressure, and passage-type homogenizers, which perform dispersion by passage through fine channels under high pressure.

Examples of processes for coating the conductive support 4 with the coating liquid for forming the undercoat layer 1 include dip coating, wire bar coating, spray coating, blade coating, knife coating, and curtain coating. The undercoat layer 1 preferably has a thickness of 15 μm or more, more preferably 20 to 50 μm. The undercoat layer 1 may contain resin particles for surface roughness control. Examples of resin particles include silicone resin particles and crosslinked poly(methyl methacrylate) (PMMA) resin particles.

The surface of the undercoat layer 1 may be polished for surface roughness control. Examples of polishing methods include buffing, sand blasting, wet honing, and grinding.

### Intermediate Layer

An intermediate layer (not shown) may be disposed on the undercoat layer 1. Examples of binder resins used for the intermediate layer include polymer resin compounds such as acetal resins (such as polyvinyl butyral), polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenolic-formaldehyde resins, and melamine resins. Other examples include organometallic compounds containing, for example, zirconium, titanium, aluminum, manganese, or silicon. These compounds may be used alone or as a mixture or polycondensation product of two or more.

Examples of solvents used for forming the intermediate layer include known organic solvents, for example, aromatic hydrocarbon solvents such as toluene and chlorobenzene; fatty alcohol solvents such as methanol, ethanol, n-propanol, isopropanol, and n-butanol; ketone solvents such as acetone, cyclohexanone, and 2-butanone; halogenated aliphatic hydrocarbon solvents such as methylene chloride, chloroform, and ethylene chloride; cyclic or linear ether solvents such as tetrahydrofuran, dioxane, ethylene glycol, and diethyl ether; and ester solvents such as methyl acetate, ethyl acetate, and n-butyl acetate. These solvents may be used alone or in a combination of two or more. Any solvent that can dissolve the binder resin as a mixed solvent can be used for mixing.

Examples of coating processes for forming the intermediate layer include common coating processes such as dip coating, wire bar coating, spray coating, blade coating, knife coating, and curtain coating.

The intermediate layer may have a thickness of 0.1 to 3 μm.

### Charge Generating Layer

The charge generating layer 2 is formed by evaporating a charge generating material or by applying a solution containing a charge generating material, an organic solvent, and a binder resin.

Examples of charge generating materials include selenium and selenium compounds such as amorphous selenium, crystalline selenium, selenium-tellurium alloy, and selenium-arsenic alloy; inorganic photoconductors such as selenium alloys, zinc oxide, and titanium oxide and those sensitized with dyes; various phthalocyanines such as metal-free phthalocyanine, titanyl phthalocyanine, copper phthalocyanine, tin phthalocyanine, and gallium phthalocyanine; various organic pigments such as squarylium pigments, anthanthrone pigments, perylene pigments, azo pigments, anthraquinone pigments, pyrene pigments, pyrylium pigments, and thiapyrylium salt pigments; and dyes.

These organic pigments generally have several crystal forms. For phthalocyanines, for example, various crystal forms are known, including the α-form and the β-form. Any crystal form may be used as long as the pigment has the desired sensitivity and other properties.

Of the above charge generating materials, phthalocyanines are preferred. A phthalocyanine contained in the photosensitive layer absorbs photons to generate carriers when irradiated with light. Phthalocyanines, having high quantum efficiency, efficiently absorb photons to generate carriers.

Examples of binder resins used for the charge generating layer 2 include polycarbonate resins, such as bisphenol A and bisphenol Z, and copolymers thereof, polyarylate resins, polyester resins, methacrylic resins, acrylic resins, polyvinyl chloride resins, polystyrene resins, polyvinyl acetate resins, styrene-butadiene copolymer resins, vinylidene chloride-acrylonitrile copolymer resins, vinyl chloride-vinyl acetate-maleic anhydride resins, silicone resins, silicone-alkyd resins, phenolic-formaldehyde resins, styrene-alkyd resins, and poly-N-vinylcarbazole.

These binder resins may be used alone or in a combination of two or more. The mixing ratio of the charge generating material to the binder resin (charge generating material:binder resin) may be 10:1 to 1:10 by mass.

Generally, the charge generating layer 2 preferably has a thickness of 0.01 to 5 μm, more preferably 0.05 to 2.0 μm.

The charge generating layer 2 may contain at least one electron-accepting material, for example, for improved sensitivity, reduced residual potential, and reduced fatigue after repeated use. Examples of electron-accepting materials used for the charge generating layer 2 include succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, and phthalic acid. In particular, fluorenones, quinones, and benzene, derivatives having an electron-withdrawing substituent such as Cl, CN, or NO₂ are preferred.

Examples of techniques for dispersing the charge generating material in the resin include roller mills, ball mills, vibrating ball mills, attritors, Dyno-Mill, sand mills, and colloid mills.

Examples of solvents used for the coating liquid for forming the charge generating layer 2 include known organic solvents, for example, aromatic hydrocarbon solvents such as toluene and chlorobenzene; fatty alcohol solvents such as methanol, ethanol, n-propanol, isopropanol, and n-butanol; ketone solvents such as acetone, cyclohexanone, and 2-butanone; halogenated aliphatic hydrocarbon solvents such as methylene chloride, chloroform, and ethylene chloride; cyclic or linear ether solvents such as tetrahydrofuran, dioxane, ethylene glycol, and diethyl ether; and ester solvents such as methyl acetate, ethyl acetate, and n-butyl acetate.

### Charge Transport Layer

The charge transport layer 3 contains a charge transport material and a binder resin or contains a polymeric charge transport material.

Known charge transport materials may be used, as exemplified below.

That is, examples of charge transport materials include hole transport materials and electron transport materials. Examples of hole transport materials include oxadiazoles such as 2,5-bis(p-diethylaminophenyl)-1,3,4-oxadiazole; pyrazolines such as 1,3,5-triphenyl-pyrazoline and 1-[pyridyl-(2)]-3-(p-diethylaminostyryl)-5-(p-diethylaminostyryl)pyrazoline; aromatic tertiary amines such as triphenylamine, tri(p-methyl)phenylamine, N,N′-bis(3,4-dimethylphenyl)biphenyl-4-amine, dibenzylaniline, and 9,9-dimethyl-N,N′-di(p-tolyl)fluorenone-2-amine; aromatic tertiary diamines such as N,N′-diphenyl-N,N′-bis(3-methylphenyl)-[1,1-biphenyl]-4,4′-diamine; 1,2,4-triazines such as 3-(4′-dimethylaminophenyl)-5,6-di-(4′-methoxyphenyl)-1,2,4-triazine; hydrazones such as 4-diethylaminobenzaldehyde-1,1-diphenylhydrazone, 4-diphenylaminobenzaldehyde-1,1-diphenylhydrazone, and [p-(diethylamino)phenyl](1-naphthyl)phenylhydrazone; quinazolines such as 2-phenyl-4-styrylquinazoline; benzofurans such as 6-hydroxy-2,3-di(p-methoxyphenyl)benzofuran; α-stilbenes such as p-(2,2-diphenylvinyl)-N,N′-diphenylaniline; enamines; carbazoles such as N-ethylcarbazole; and poly-N-vinylcarbazole and derivatives thereof. Examples of electron transport materials include quinones such as chloranil, bromanil, and anthraquinone; tetracyanoquinodimethanes; fluorenones such as 2,4,7-trinitrofluorenone and 2,4,5,7-tetranitro-9-fluorenone; oxadiazoles such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthones; thiophenes; and diphenoquinones such as 3,3′,5,5′-tetra-t-butyldiphenoquinone. Other examples include polymers having a group derived from the compounds shown above in the main chain or a side chain thereof. These charge transport materials may be used alone or in a combination of two or more.

Examples of binder resins used for the charge transport layer 3 include biphenyl-polycarbonate copolymer resins; polycarbonate resins such as bisphenol A and bisphenol Z; acrylic resins; methacrylic resins; polyarylate resins; polyester resins; polyvinyl chloride resins; polystyrene resins; acrylonitrile-styrene copolymer resins; acrylonitrile-butadiene copolymer resins; polyvinyl acetate resins; polyvinyl formal resins; polysulfone resins; styrene-butadiene copolymer resins; vinylidene chloride-acrylonitrile copolymer resins; vinyl chloride-vinyl acetate-maleic anhydride resins; silicone resins; phenolic-formaldehyde resins; polyacrylamide resins; polyamide resins; insulating resins such as chlorinated rubber; and organic photoconductive polymers such as polyvinylcarbazole, polyvinylanthracene, and polyvinylpyrene. These binder resins may be used alone or in a combination of two or more.

The charge transport layer 3 is formed using a coating liquid containing the above components and a solvent. Examples of solvents used for forming the charge transport layer 3 include known organic solvents, for example, aromatic hydrocarbon solvents such as toluene and chlorobenzene; fatty alcohol solvents such as methanol, ethanol, n-propanol, isopropanol, and n-butanol; ketone solvents such as acetone, cyclohexanone, and 2-butanone; halogenated aliphatic hydrocarbon solvents such as methylene chloride, chloroform, and ethylene chloride; cyclic or linear ether solvents such as tetrahydrofuran, dioxane, ethylene glycol, and diethyl ether; and ester solvents such as methyl acetate, ethyl acetate, and n-butyl acetate. These solvents may be used alone or in a combination of two or more. Any solvent that can dissolve the binder resin may be used in combination.

The mixing ratio of the charge transport material to the binder resin may be 10:1 to 1:5 by mass.

Examples of processes for coating the charge generating layer 2 with the thus-prepared coating liquid for forming the charge transport layer 3 include common processes such as dip coating, wire bar coating, spray coating, blade coating, knife coating, and curtain coating.

The charge transport layer 3 preferably has a thickness of 5 to 50 μm, more preferably 10 to 40 μm.

### Charging Unit

The charging device 8 used is, for example, a known charger such as a noncontact roller charger or a corotron or scorotron charger, which uses corona discharge. Contact chargers may also be used, including conductive or semiconductive charging rollers, charging brushes, charging films, charging rubber blades, and charging tubes.

### Electrostatic-Latent-Image Forming Unit

The exposure device 9, as an electrostatic-latent-image forming unit, is, for example, an optical device that exposes the surface of the photoreceptor 7 in the desired image pattern with light such as semiconductor laser light, LED light, or liquid crystal shutter light. The light source used is one whose wavelength falls within the spectral sensitivity range of the photoreceptor 7. A typical semiconductor laser has its oscillation wavelength near 780 nm, that is, in the near-infrared region. The wavelength, however, is not limited thereto; a laser having its oscillation wavelength in the range of 600 to 700 nm or a laser having its oscillation wavelength in the range of 400 to 450 nm, which is a blue laser, may also be used. In addition, surface-emitting lasers capable of multibeam output are effective for formation of color images.

### Developing Unit

The developing device 11 used is one configured to store a developer containing a toner manufactured by dispersing particles for forming the toner in a solvent containing water and aggregating and heating the particles and to form a toner image on the surface of the photoreceptor 7 on which an electrostatic latent image is formed. For example, developing devices may be used that develop an electrostatic latent image with, for example, a magnetic or nonmagnetic one-component or two-component developer with or without contact, including known developing devices that deposit the one-component or two-component developer on the photoreceptor 7 with, for example, a brush or a roller.

### Toner

The toner used in this exemplary embodiment is prepared by emulsion aggregation, in which toner particles are formed by mixing a dispersion prepared by emulsion polymerization of a polymerizable monomer of a binder resin with, for example, dispersions of a colorant, a release agent, and a charge control agent and aggregating and thermally fusing the particles. The toner may be prepared by a wet process in which aggregation is performed in two steps.

A toner manufactured by emulsion aggregation, which has a higher water content than a toner manufactured by crushing, typically contains 0.5% to 2% by mass of water.

Specifically, an emulsion aggregation process includes a step of mixing and aggregating by heating a resin particle dispersion in which resin particles are dispersed, a colorant particle dispersion in which colorant particles are dispersed, a release agent particle dispersion in which release agent particles are dispersed, and other materials such as an aggregating agent to form aggregated particles; and a step of fusing the aggregated particles by heating to a temperature higher than or equal to the glass transition temperature of the resin particles to form toner particles. The aggregated particles may be formed by heating or controlling the pH of the mixed dispersion containing the resin particles, the colorant particles, and the release agent particles, or by further mixing an aggregating agent.

Additives such as an inorganic oxide and a charge control agent dispersion may be added during the formation of the aggregated particles. In addition, a resin particle dispersion may be added to deposit resin particles.

### Binder Resin

Examples of thermoplastic binder resins available as the toner resin used in this exemplary embodiment include polymers and copolymers, as well as mixtures thereof, of monomers such as styrenes such as styrene, p-chlorostyrene, and α-methylstyrene; vinyl-containing esters such as methyl acrylate, ethyl acrylate, n-propyl acrylate, lauryl acrylate, 2-ethylhexyl acrylate, methyl methacrylate, ethyl methacrylate, n-propyl methacrylate, lauryl methacrylate, and 2-ethylhexyl methacrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; and polyolefins such as ethylene, propylene, and butadiene. Other examples include non-vinyl-condensation resins such as epoxy resins, polyester resins, polyurethane resins, polyamide resins, cellulose resins, and polyether resins; mixtures of the above non-vinyl-condensation resins with the above vinyl resins; and graft copolymers formed by polymerization of the above vinyl monomers together with the above non-vinyl-condensation resins.

The resin particle dispersion is easily prepared by emulsion polymerization or a similar polymerization method. The resin particle dispersion may be prepared by any method, such as by adding a polymer formed in advance by, for example, solution polymerization or bulk polymerization to a solvent in which the polymer is insoluble together with a stabilizer and mechanically mixing and dispersing the mixture.

For vinyl monomers, for example, the resin particle dispersion is prepared by emulsion polymerization or suspension polymerization using, for example, an ionic surfactant, depending on the method used. For other resins soluble in an oily solvent having relatively low solubility in water, the resin particle dispersion is prepared by dissolving the resin in the solvent, dispersing the solution in water in particle form together with an ionic surfactant or a polymer electrolyte using a dispersing machine such as a homogenizer, and evaporating the solvent under heat or reduced pressure.

The resin particles in the resin particle dispersion preferably have a volume average particle size of 1 μm or less, more preferably 100 to 800 nm.

Examples of surfactants include, but not limited to, anionic surfactants such as sulfate esters, sulfonate salts, phosphate esters, and soaps; cationic surfactants such as amine salts and quaternary ammonium salts; nonionic surfactants such as polyethylene glycols, alkylphenol-ethylene oxide adducts, alkyl alcohol-ethylene oxide adducts, and polyalcohols; and various graft copolymers.

If the resin particle dispersion is prepared by emulsion polymerization, a small amount of unsaturated acid, such as acrylic acid, methacrylic acid, maleic acid, or styrenesulfonic acid, may be added to form a protective colloid layer for soap-free polymerization.

The resin particles preferably have a glass transition temperature of 45° C. to 65° C., more preferably 50° C., to 60° C., still more preferably 53° C. to 60° C.

The resin particles preferably have a weight average molecular weight Mw of 15,000 to 60,000, more preferably 20,000 to 50,000, still more preferably 25,000 to 40,000.

### Release Agent

Examples of release agents include low-molecular-weight polyolefins such as polyethylene, polypropylene, and polybutene; silicones that exhibit a softening point when heated; fatty acid amides such as oleamide, erucamide, ricinoleamide, and stearamide; vegetable waxes such as carnauba wax, rise wax, candelilla wax, Japan wax, and jojoba oil; animal waxes such as beeswax; mineral and petroleum waxes such as montan wax, ozokerite, ceresin, paraffin wax, microcrystalline wax, and Fischer-Tropsch wax; and modified products thereof.

The amount of release agent added is preferably 5% to 20% by mass, more preferably 7% to 13% by mass.

### Colorant

As the colorant, for example, various pigments and dyes may be used alone or in a combination of two or more.

Examples of colorants include various pigments such as carbon black, chrome yellow, Hanza yellow, benzidine yellow, threne yellow, quinoline yellow, permanent yellow, permanent orange GTR, pyrazolone orange, Vulcan orange, watching red, permanent red, brilliant carmine 3B, brilliant carmine 6B, Dupont oil red, pyrazolone red, lithol red, rhodamine B lake, lake red C, rose bengal, aniline blue, ultramarine blue, calco oil blue, methylene blue chloride, phthalocyanine blue, phthalocyanine green, and malachite green oxalate; and various dyes such as acridone dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, triphenylmethane dyes, diphenylmethane dyes, and thiazole dyes. These colorants may be used alone or in a combination of two or more.

If the toner is used as a magnetic toner, a magnetic powder of, for example, a metal such as ferrite, magnetite, reduced iron, cobalt, nickel, or manganese, or an alloy or compound thereof, is used.

The colorant may be dispersed by any method, for example, by a common dispersion technique such as a rotary shear homogenizer, a ball mill, a sand mill, Dyno-Mill, or Ultimaizer. The colorant is dispersed in water together with, for example, an ionic surfactant or a polymer electrolyte such as a polymer acid or a polymer base.

If the toner is manufactured by emulsion aggregation, the dispersed particles for forming the toner particles may have a particle size of 1 μm or less, either for core aggregation or for addition to core particles (additional particles). If the dispersed particles have a particle size of more than 1 μm, the toner particles finally formed have a broad particle size distribution, and free particles are produced, thus decreasing the performance and reliability.

The amount of dispersion of the additional particles, which depends on the volume fraction of the particles contained therein, may be determined such that the volume of the additional particles is 50% or less of the volume of the aggregated particles finally formed. If the volume of the additional particles is 50% or less of the volume of the aggregated particles finally formed, they aggregate with the core particles, rather than form new aggregated particles. This inhibits the composition distribution and the particle size distribution from becoming wider.

In addition, if the particles are added stepwise or gradually and continuously, they do not form new, extremely small aggregated particles. This narrows the particle size distribution.

Furthermore, if the temperature is raised at each step of addition within the range up to the glass transition temperature of the core aggregated particles or the additional particles, fewer free particles are produced.

### Aggregating Agent

The aggregating agent used is preferably a surfactant having opposite polarity to those used for the resin particle dispersion and the colorant particle dispersion or a divalent or multivalent inorganic metal salt, more preferably an inorganic metal salt.

Examples of inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide. In particular, aluminum salts and polymers thereof are preferred. To attain a sharper particle size distribution, inorganic metal salts having higher valences are more suitable, and among inorganic metal salts having the same valence, inorganic metal salt polymers are more suitable.

The amount of aggregating agent added, which depends on the ion concentration in aggregation, is preferably 0.05% to 1.00% by mass, more preferably 0.10% to 0.50% by mass, of the solid content (toner content) of the mixed solution.

To form toner particles having the desired particle size and shape, after the formation of aggregated particles by aggregating the resin particles, the colorant particles, and the release agent particles, the aggregated particles are subjected to pH adjustment to stabilize the particle size thereof and are fused by heating to the glass transition temperature of the resin particles or higher while controlling the temperature, the time, and the pH. The fused particles are subjected to, for example, a solid-liquid separation step such as filtration, a cleaning step, and a drying step to obtain toner particles.

In the cleaning step, the particles may be treated with an acid such as nitric acid, sulfuric acid, or hydrochloric acid or an alkali solution such as a sodium hydroxide solution and be cleaned with, for example, ion exchange water.

The drying step may be carried out by any method, for example, by a common method such as vibration fluidized drying, spray drying, freeze drying, or flush jetting, preferably by the use of a pneumatic dryer such as a flash jet dryer.

The developer used for the image-forming apparatus 100 according to this exemplary embodiment may contain tetrafluoroethylene-containing particles containing a polymer having structural units derived from tetrafluoroethylene. The tetrafluoroethylene-containing particles supplied together with the toner by the developing device 11 form a thin film containing the polymer having structural units derived from tetrafluoroethylene on the surface of the photoreceptor 7. If the developer contains the tetrafluoroethylene-containing particles, the protective layer 5 of the photoreceptor 7 does not necessarily have to contain the tetrafluoroethylene-containing particles. If the protective layer 5 of the photoreceptor 7 contains the tetrafluoroethylene-containing particles, however, they are supplied to the surface of the photoreceptor 7 as the protective layer 5 wears. In contrast, for example, if the tetrafluoroethylene-containing particles are externally added to the toner particles, they need to be removed from the toner particles by a member, such as a cleaning blade, that contacts the surface of the photoreceptor 7. Thus, the protective layer 5 of the photoreceptor 7 may contain the tetrafluoroethylene-containing particles.

### Transfer Unit

The transfer device 40 used is, for example, a known transfer charger such as a contact transfer charger including, for example, a belt, a roller, a film, or a rubber blade, or a corotron or scorotron transfer charger, which uses corona discharge.

### Intermediate Transfer Member

The intermediate transfer member 50 used may be a belt (intermediate transfer belt) formed of a material such as semiconductive polyimide, polyamideimide, polycarbonate, polyarylate, polyester, or rubber. Instead of a belt, the intermediate transfer member 50 may be a drum.

### Cleaning Unit

The cleaning device 13 removes residual toner from the surface of the photoreceptor 7 after transfer by bringing a cleaning blade 131 having a rubber edge into contact with the surface of the photoreceptor 7. The cleaning device 13 is configured to substantially enclose part of the surface of the photoreceptor 7 to collect the toner removed from the surface of the photoreceptor 7 by the cleaning blade 131.

The cleaning device 13 may include a fibrous member 132 for supplying a lubricant 14 to the surface of the photoreceptor 7. In addition, the cleaning device 13 may optionally include a fibrous member 133 (flat brush) for assisting in cleaning.

### Supply Unit

In addition to the developing unit, the image-forming apparatus 100 according to this exemplary embodiment may include a supply unit (not shown) that supplies the tetrafluoroethylene-containing particles to the surface of the photoreceptor 7. With the supply unit, the tetrafluoroethylene-containing particles are reliably supplied to the surface of the photoreceptor 7.

In addition to the devices described above, the image-forming apparatus 100 may include, for example, an optical static eliminator that optically eliminates static from the photoreceptor 7.

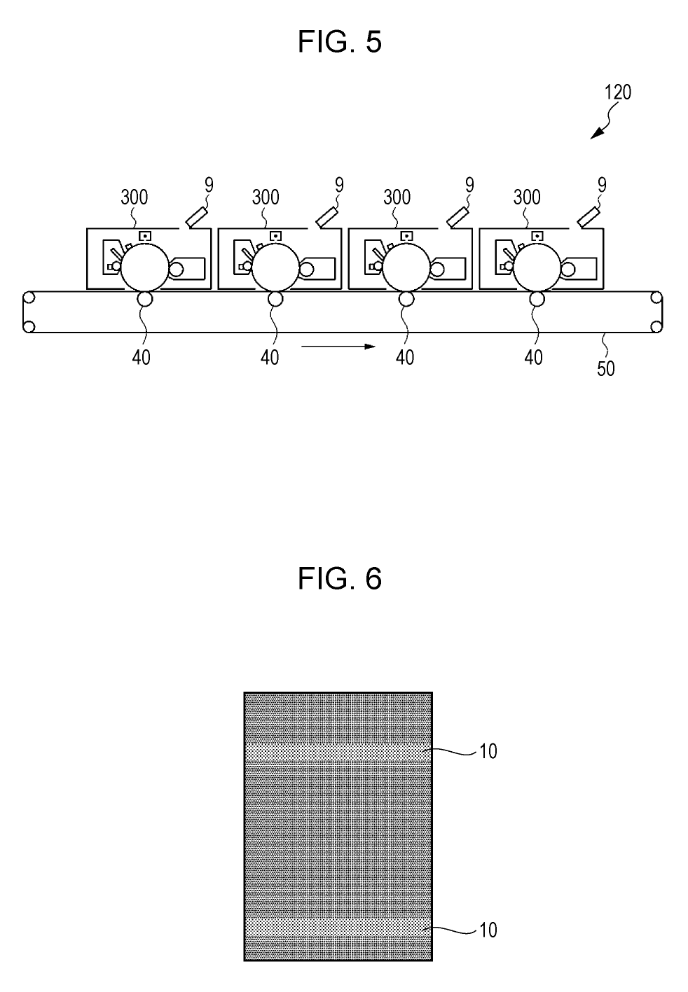

FIG. 5 is a schematic sectional view showing an image-forming apparatus according to another exemplary embodiment. An image-forming apparatus 120 is a tandem color image-forming apparatus equipped with four process cartridges 300. In the image-forming apparatus 120, the four process cartridges 300 are arranged in parallel along an intermediate transfer member 50, and one electrophotographic photoreceptor is used for each color.

In the thus-configured image-forming apparatus 120, formation of bands of decreased image density is inhibited if each process cartridge 300 includes an electrophotographic photoreceptor including an outermost layer that has a crosslinked structure formed by dehydration condensation of a charge transport monomer containing a hydroxyl group and that contains tetrafluoroethylene-containing particles containing a polymer having structural units derived from tetrafluoroethylene; and a developing device configured to develop an electrostatic image on the surface of the electrophotographic photoreceptor with a developer containing a toner manufactured by dispersing particles for forming the toner in a solvent containing water and aggregating and heating the particles to form a toner image.

### EXAMPLES

The invention will be further illustrated by the following examples and comparative examples, although they should not be construed as limiting the invention. In the examples, parts are by mass unless otherwise specified.

### Preparation of Toner

### Preparation of Resin Dispersion 1

Styrene 370 g

n-Butyl acrylate 30 g

Acrylic acid 6 g

Dodecanethiol 24 g

Carbon tetrabromide 4 g

The above components are mixed and dissolved together. The solution is added to a solution of 6 g of nonionic surfactant Nonipol 400 and 10 g of anionic surfactant Neogen SC in 550 g of ion exchange water and is dispersed and emulsified in a flask. The emulsion is mixed with 50 g of ion exchange water in which 4 g of ammonium persulfate is dissolved with gentle stirring for ten minutes and is purged with nitrogen. The content of the flask is then heated to 70° C. in an oil bath with stirring to continue emulsion polymerization for five hours.

Thus, an anionic resin dispersion is obtained that has a central particle diameter of 155 nm, a glass transition point of 59° C., and a weight average molecular weight Mw of 12,000.

### Preparation of Resin Dispersion 2

Styrene 280 g

n-Butyl acrylate 120 g

Acrylic acid 8 g

The above components are mixed and dissolved together. The solution is added to a solution of 6 g of nonionic surfactant Nonipol 400 and 12 g of anionic surfactant Neogen SC in 550 g of ion exchange water and is dispersed and emulsified in a flask. The emulsion is mixed with 50 g of ion exchange water in which 3 g of ammonium persulfate is dissolved with gentle stirring for ten minutes and is purged with nitrogen. The content of the flask is then heated to 70° C. in an oil bath with stirring to continue emulsion polymerization for five hours.

Thus, an anionic resin dispersion is obtained that has a central particle diameter of 105 nm, a glass transition point of 53° C., and a weight average molecular weight Mw of 550,000.

### Preparation of Pigment Dispersion

Carbon black Mogul L (Cabot Corporation) 50 g

Nonionic surfactant Nonipol 400 5 g

Ion exchange water 200 g

The above components are mixed together and are dispersed using a homogenizer (IKA ULTRA-TURRAX) for ten minutes to obtain a carbon black dispersion having a central particle size of 250 nm.

### Preparation of Release Agent Dispersion

Paraffin wax HNP0190 (melting point: 85° C.; Nippon Seiro Co., Ltd.) 50 g

Cationic surfactant SANISOL B-50 (Kao Corporation) 5 g

Ion exchange water 200 g

The above components are heated to 95° C., are dispersed using ULTRA-TURRAX T50 from IKA, and are subjected to dispersion treatment using a pressure ejection homogenizer to obtain a wax dispersion having a central particle size of 550 nm.

### Preparation of Aggregated Particles

Resin dispersion 1 120 g

Resin dispersion 2 80 g

Pigment dispersion 30 g

Release agent dispersion 40 g

SANISOL B-50 1.5 g

The above components are mixed and dispersed in a stainless round-bottom flask using ULTRA-TURRAX T50 from IKA. The dispersion is then heated to 48° C. in a heating oil bath with stirring. After the dispersion is maintained at 48° C. for 30 minutes, aggregated particles having an average particle size of about 5 μm are found under an optical microscope. The dispersion is then gently mixed with 60 g of resin dispersion 1 and is maintained at 50° C. for one hour by raising the temperature of the heating oil bath.

When observed under an optical microscope, aggregated particles having an average particle size of about 5.7 μm are found.

Subsequently, 3 g of Neogen SC is added, the stainless flask is sealed, and the dispersion is heated to 105° C. with stirring using a magnetic seal and is maintained for three hours.

After cooling, the particles are filtered out and are sufficiently cleaned with ion exchange water. The particle size measured using a Coulter counter is 5.6 μm.

### Developer A

Toner 1 is prepared by mixing 100 parts by mass of the above aggregated particles with 0.5 parts by mass of silica particles having an average particle size of 12 nm and 1.0 part by mass of silica particles having an average particle size of 40 nm using a Henschel mixer.

Developer A is prepared by externally adding inorganic particles, as a charge control agent, to toner 1 and mixing it with a PMMA-coated ferrite carrier having an average particle size of 50 μm.

### Developer B

Toner 2 is prepared by mixing 100 parts by mass of the above aggregated particles with 0.5 parts by mass of silica particles having an average particle size of 12 nm, 1.0 part by mass of silica particles having an average particle size of 40 nm, and 0.3 parts by mass of PTFE particles (Lubron L-2) using a Henschel mixer.

Developer B is prepared by externally adding inorganic particles, as a charge control agent, to toner 2 and mixing it with a PMMA-coated ferrite carrier having an average particle size of 50 μm.

### Production of Photoreceptor

### Photoreceptor A

### Undercoat Layer

A hundred parts of zinc oxide (average particle size: 70 nm; Tayca Corporation; specific surface area: 15 m²/g) is mixed and stirred with 500 parts of toluene. Also added is 1.25 parts of a silane coupling agent (KBM603 from Shin-Etsu Chemical Co., Ltd.), and the mixture is stirred for two hours. After toluene is removed by vacuum distillation, the zinc oxide is baked at 120° C. for three hours for surface treatment with the silane coupling agent.

A hundred parts of the surface-treated zinc oxide is mixed and stirred with 500 parts of tetrahydrofuran. Also added is a solution of 1 part of alizarin in 50 parts of tetrahydrofuran, and the mixture is stirred at 50° C. for five hours. Subsequently, the alizarin-added zinc oxide is filtered out by vacuum filtration and is dried at 60° C. in a vacuum to obtain an alizarin-added zinc oxide pigment.

Dissolved in 85 parts of methyl ethyl ketone are 60 parts of the alizarin-added zinc oxide pigment, 13.5 parts of a blocked isocyanate (Sumidur 3175 from Sumika Bayer Urethane Co., Ltd.), as a curing agent, and 15 parts of a butyral resin (S-LEC BM-1 from Sekisui Chemical Co., Ltd.). Then, 38 parts of the resulting solution is mixed with 25 parts of methyl ethyl ketone and is dispersed with glass beads having a diameter of 1 mm in a sand mill for two hours to prepare a dispersion.

The resulting dispersion is mixed with 0.005 parts of dioctyltin dilaurate, as a catalyst, and 40 parts of silicone resin particles (Tospearl 145 from GE Toshiba Silicones Co., Ltd.) and is dried and cured at 170° C. for 40 minutes to obtain a coating liquid for forming an undercoat layer.

The coating liquid for forming an undercoat layer is applied onto an aluminum substrate having a diameter of 84 mm, a length of 347 mm, and a thickness of 1 mm by dip coating to form an undercoat layer having a thickness of 21 μm.

### Charge Generating Layer

One part of chlorogallium phthalocyanine crystal, as a charge generating material, which shows intense diffraction peaks at Bragg angles)(20±0.2° of 7.4°, 16.6°, 25.5°, and 28.3° in its X-ray diffraction spectrum, and 1 part of a polyvinyl butyral resin (S-LEC BM-S from Sekisui Chemical Co., Ltd.) are mixed with 100 parts of butyl acetate and is dispersed with glass beads in a paint shaker for one hour to obtain a coating liquid for forming a charge generating layer.

The coating liquid for forming a charge generating layer is applied onto the surface of the undercoat layer by dip coating and is dried by heating at 100° C. for ten minutes to form a charge generating layer having a thickness of 0.2 μm.

### Charge Transport Layer

A coating liquid for forming a charge transport layer is prepared by dissolving, in 10 parts of tetrahydrofuran and 5 parts of toluene, 2 parts of charge transport material A1 (first charge transport material) represented by the following formula and 3 parts of a polymer compound (viscosity average molecular weight: 39,000) represented by structural formula 1:

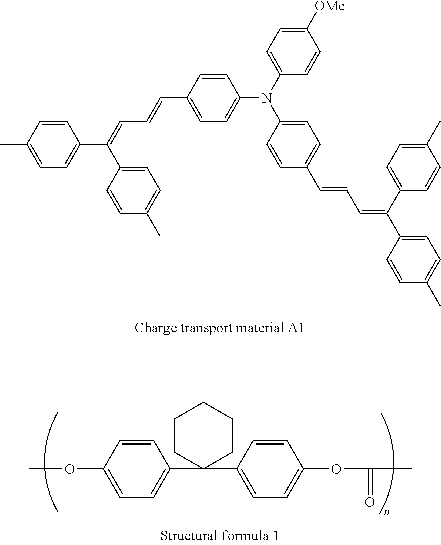

The coating liquid for forming a charge transport layer is applied onto the surface of the charge generating layer by dip coating and is dried by heating at 135° C. for 35 minutes to form a charge transport layer having a thickness of 22 μm. This photoreceptor is referred to as a base photoreceptor.

### Protective Layer

An ethylene tetrafluoride resin particle suspension is prepared by sufficiently mixing and stirring, in 16 parts of cyclopentanone, 4 parts of Lubron L-2 (from Daikin Industries, Ltd.; particle size: 0.2 μm), as ethylene tetrafluoride resin particles, and 0.2 parts of a fluoroalkyl-containing copolymer containing repeating units represented by structural formula 2 (weight average molecular weight: 50,000, l:m=1:1, s=1, n=60):

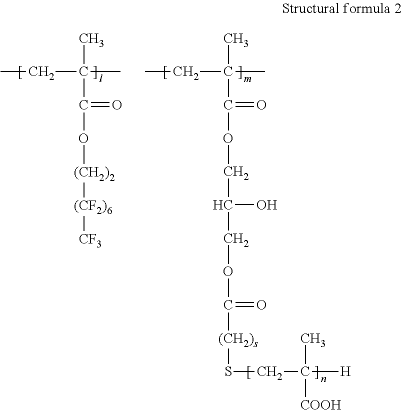

Next, 94 parts of a charge transport compound and 1 part of a benzoguanamine resin are sufficiently mixed and dissolved in 220 parts of cyclopentanone. The solution is then mixed and stirred with the ethylene tetrafluoride resin particle suspension and is subjected to dispersion treatment 30 times under a pressure of 700 kgf/cm² using a high-pressure homogenizer (YSNM-1500AR from Yoshida Kikai Co., Ltd.) equipped with a passage chamber with fine channels. The charge transport compound is represented by structural formula A:

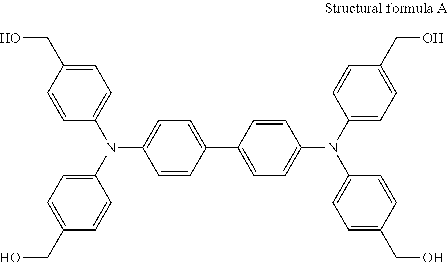 [SMILES: OCc1ccc(N(c2ccc(CO)cc2)c2ccc(-c3ccc(N(c4ccc(CO)cc4)c4ccc(CO)cc4)cc3)cc2)cc1]

Subsequently, 0.9 parts of dimethylpolysiloxane (GLANOL 450 from Kyoeisha Chemical Co., Ltd.) and 0.1 part of NACURE 5225 (from King Industries) are added to prepare a coating liquid for forming a protective layer.

The coating liquid for forming a protective layer is applied onto the base photoreceptor by dip coating and is dried at 155° C. for 40 minutes to form a protective layer having a thickness of 6 μm. This photoreceptor is referred to as photoreceptor A.

### Photoreceptor B

Photoreceptor B is produced in the same manner as photoreceptor A except that the ethylene tetrafluoride resin particles used for the protective layer of photoreceptor A, namely, Lubron L-2 (from Daikin Industries, Ltd.), are replaced with ethylene tetraflubride-propylene hexafluoride copolymer particles, namely, FEP120-JR (from Du Pont-Mitsui Fluorochemicals Co., Ltd.; particle size: 0.2 μm).

### Photoreceptor C

A coating liquid for forming a protective layer is prepared without using the ethylene tetrafluoride resin particles used for the protective layer of photoreceptor A, namely, Lubron L-2 (from Daikin Industries, Ltd.); that is, it is prepared by adding 94 parts of the charge transport compound of structural formula A and 1 part of a benzoguanamine resin to 220 parts of cyclopentanone and then adding 0.9 parts of dimethylpolysiloxane (GLANOL 450 from Kyoeisha Chemical Co., Ltd.) and 0.1 part of NACURE 5225 (from King Industries). The coating liquid for forming a protective layer is applied onto the base photoreceptor by dip coating and is dried at 155° C. for 40 minutes to form a protective layer having a thickness of 6 μm. This photoreceptor is referred to as photoreceptor C.

### Photoreceptor D

Photoreceptor D is produced in the same manner as photoreceptor A except that the ethylene tetrafluoride resin particles used for the protective layer of photoreceptor A, namely, Lubron L-2 (from Daikin Industries, Ltd.), are replaced with PVDF particles (from Arkema; particle size: 1.0 μm).

### Evaluation

With the combinations of the photoreceptors and the developers shown in Table 1, 10,000 copies of a chart with a coverage of 10% are printed using a C1000 digital printing press from Fuji Xerox Co., Ltd. After the printing press is left at room temperature and humidity for three days, a full-page halftone image (coverage: 50%) is output and is evaluated for density decrease as follows:

Excellent: no density difference

Good: extremely slight, negligible density difference

Fair: slight density difference

Poor: noticeable density difference

The results are shown in Table 1.

TABLE 1

| | Photoreceptor | Developer | Density decrease |
|---|---|---|---|
| Example 1 | A | A | Excellent |
| Example 2 | A | B | Excellent |
| Example 3 | B | A | Good |
| Example 4 | B | B | Excellent |
| Example 5 | C | B | Good |
| Comparative | C | A | Poor |
| Example 1 | | | |
| Comparative | D | A | Fair |
| Example 2 | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-forming apparatus comprising:
an electrophotographic photoreceptor including an outermost layer having a crosslinked structure formed by dehydration condensation of a charge transport monomer containing a hydroxyl group;
a charging unit that charges a surface of the electrophotographic photoreceptor;
a latent-image forming unit that forms an electrostatic latent image on the charged surface of the electrophotographic photoreceptor;
a developing unit that develops the electrostatic latent image on the surface of the electrophotographic photoreceptor with a developer containing a toner manufactured by dispersing particles for forming the toner in a solvent containing water and aggregating and heating the particles to form a toner image;
a transfer unit that transfers the toner image from the surface of the electrophotographic photoreceptor onto a transfer medium; and
a cleaning unit that removes residual toner from the surface of the electrophotographic photoreceptor after the transfer,
the image-forming apparatus satisfying at least one of the following conditions:
(1) the outermost layer of the electrophotographic photoreceptor contains tetrafluoroethylene-containing particles containing a polymer having structural units derived from tetrafluoroethylene;
(2) the developer contains tetrafluoroethylene-containing particles containing a polymer having structural units derived from tetrafluoroethylene; and
(3) the image-forming apparatus further comprises a supply unit that supplies tetrafluoroethylene-containing particles containing a polymer having structural units derived from tetrafluoroethylene to the surface of the electrophotographic photoreceptor.

2. The image-forming apparatus according to claim 1, wherein the tetrafluoroethylene-containing particles contain polytetrafluoroethylene.

3. The image-forming apparatus according to claim 1, wherein the tetrafluoroethylene-containing particles have a volume average particle size of about 1 μm or less.

4. The image-forming apparatus according to claim 2, wherein the tetrafluoroethylene-containing particles have a volume average particle size of about 1 μm or less.

5. An electrophotographic photoreceptor comprising an outermost layer having a crosslinked structure formed by dehydration condensation of a charge transport monomer containing a hydroxyl group, the outermost layer containing tetrafluoroethylene-containing particles containing a polymer having structural units derived from tetrafluoroethylene,
the electrophotographic photoreceptor being used for an image-forming apparatus that develops an electrostatic latent image on a surface of the electrophotographic photoreceptor with a developer containing a toner manufactured by dispersing particles for forming the toner in a solvent containing water and aggregating and heating the particles to form a toner image.

6. The electrophotographic photoreceptor according to claim 5, wherein the tetrafluoroethylene-containing particles contain polytetrafluoroethylene.

7. The electrophotographic photoreceptor according to claim 5, wherein the tetrafluoroethylene-containing particles have a volume average particle size of about 1 μm or less.

8. The electrophotographic photoreceptor according to claim 6, wherein the tetrafluoroethylene-containing particles have a volume average particle size of about 1 μm or less.

9. A process cartridge comprising an electrophotographic photoreceptor including an outermost layer having a crosslinked structure formed by dehydration condensation of a charge transport monomer containing a hydroxyl group, the outermost layer containing tetrafluoroethylene-containing particles containing a polymer having structural units derived from tetrafluoroethylene,
the process cartridge being attachable to and detachable from an image-forming apparatus that develops an electrostatic latent image on a surface of the electrophotographic photoreceptor with a developer containing a toner manufactured by dispersing particles for forming the toner in a solvent containing water and aggregating and heating the particles to form a toner image.

10. The process cartridge according to claim 9, wherein the tetrafluoroethylene-containing particles contain polytetrafluoroethylene.

11. The process cartridge according to claim 9, wherein the tetrafluoroethylene-containing particles have a volume average particle size of about 1 μm or less.

12. The process cartridge according to claim 10, wherein the tetrafluoroethylene-containing particles have a volume average particle size of about 1 μm or less.
